(19) United States
(12) Patent Application Publication
(10) Pub. No.: US 2020/0231872 A1
(43) Pub. Date: Jul. 23, 2020

(54) PHOSPHOR AND A COMPOSITION

(71) Applicant: MERCK PATENT GMBH, DARMSTADT (DE)

(72) Inventors: Hiroshi OKURA, Kanagawa (JP); Stephan DERTINGER, Heidelberg (DE); Tarunjot SINGH, Frankfurt am Main (DE); Ryuta SUZUKI, Iwaki (JP); Kazuhisa AZUMA, Fukushima (JP); Eiji NISHIHARA, Tottori (JP); Tadashi ISHIGAKI, Tottori (JP); Koutoku OHMI, Tottori-shi (JP); Ryota YAMANASHI, Ebina (JP); Kenji TODA, Niigata (JP); Daniel SZABO, Darmstadt (DE); Noriyuki MATSUDA, Frankfurt am Main (DE)

(73) Assignee: MERCK PATENT GMBH, DARMSTADT (DE)

(21) Appl. No.: 16/633,967

(22) PCT Filed: Jul. 24, 2018
(86) PCT No.: PCT/EP2018/069991

§ 371 Date: Jan. 24, 2020

(30) Foreign Application Priority Data
Jul. 26, 2017 (EP) 17183343.7
Mar. 16, 2018 (EP) 18162413.1

(51) Int. Cl. C09K 11/70; C09K 11/77; C09K 11/67; A01N 59/16; C09K 11/02

(52) U.S. Cl. CPC C09K 11/70; C09K 11/7728; C09K 11/7706; C09K 11/025; C09K 11/7708; A01N 59/16; C09K 11/67

(57) ABSTRACT

The present invention relates to a phosphor and a composition.

### FIELD OF THE INVENTION

The present invention relates to a composition, a formulation, an optical medium, an optical device, an inorganic phosphor, use, a plant, a method for manufacturing thereof.

### BACKGROUND ART

JP 2007-135583 A mentions an organic dye having a peak wavelength at 613 nm and suggestion to use it with a thermoplastic resin as an agriculture film.

A polypropylene film containing an organic dye with peak light emission wavelength at 592 nm is disclosed in WO 1993/009664 A1.

JP H09-249773 A mentions an organic dye having peak light wavelength at 592 nm and a suggestion to use it with a polyolefin resin as an agriculture film.

A combination of an ultraviolet light emitting diode, blue, red, yellow light emitting diodes for green house light source is disclosed in JP 2001-28947 A.

JP 2004-113160 A discloses a plant growth kit with a light emitting diode light source containing blue and red light emitting diodes.

(Ba,Ca,Sr)₃MgSi₂O8:Eu²⁺, Mn²⁺ phosphors such as (Ba_{0.97}Eu_{0.03})₃(Mg_{0.95}Mn_{0.05})Si₂O₈, (Ba_{0.735} Sr_{0.235}Eu_{0.03})₃(Mg_{0.95}Mn_{0.05}) Si₂O₈ with a peak light emission wavelength around 625 nm, and a suggestion to use it as an agricultural lamp is described on Han et al., Journal of luminescence (2014), vol. 148, p 1-5.

### PATENT LITERATURE

1. JP 2007-135583 A
2. WO 1993/009664 A1
3. JP H09-249773A
4. JP 2001-28947A
5. JP 2004-113160A

### NON-PATENT LITERATURE

6. “Analysis of (Ba,Ca,Sr)₃MgSi₂O8:Eu²⁺, Mn²⁺ phosphors for application in solid state lighting”, Han et al., Journal of luminescence (2014), vol. 148, p 1-5

### SUMMARY OF THE INVENTION

The inventors surprisingly have found that there are still one or more considerable problems for which improvement are desired, as listed below; improvement of controlling property of a phytoplankton condition, photosynthetic bacteria and/or alga, preferably acceleration of growth of phytoplankton, photosynthetic bacteria and/or alga; improvement of controlling property of plant condition, preferably controlling of a plant height; controlling of color of fruits; promotion and inhibition of germination; controlling of synthesis of chlorophyll and carotenoids, preferably by blue light; plant growth promotion; adjustment and/or acceleration of flowering time of plants; controlling of production of plant components, such as increasing production amount, controlling of polyphenols content, sugar content, vitamin content of plants; controlling of secondary metabolites, preferably controlling of polyphenols, and/or anthocyanins; controlling of a disease resistance of plants; controlling of ripening of fruits, or controlling of weight of plant.

Then, it is found that a novel composition comprising at least one inorganic phosphor having a peak wavelength of light emitted from the inorganic phosphor in the range of 650 nm or more, preferably in the range from 650 to 1500 nm, more preferably in the range from 650 to 1000 nm, even more preferably in the range from 650 to 800 nm, furthermore preferably in the range from 650 to 750 nm, much more preferably it is from 660 nm to 730 nm, furthermore preferably it is from 660 nm to 710 nm, the most preferably from 670 nm to 71 nm,

and/or at least one inorganic phosphor having a peak wavelength of light emitted from the inorganic phosphor in the range of 500 nm or less, preferably in the range from 250 nm to 500 nm, more preferably in the range from 300 nm to 500 nm, even more preferably in the range from 350 nm to 500 nm, furthermore preferably in the range from 400 nm to 500 nm, much more preferably in the range from 420 nm to 480 nm, the most preferably in the rage from 430 nm to 460 nm,

and/or at least one inorganic phosphor having a first peak wavelength of light emitted from the inorganic phosphor in the range of 500 nm or less, and a second peak wavelength of light emitted from the inorganic phosphor in the range of 650 nm or more, preferably the first peak wavelength of light emitted from the inorganic phosphor is in the range from 250 nm to 500 nm, and the second peak light emission wavelength is in the range from 650 nm to 1500 nm, more preferably the first peak wavelength of light emitted from the inorganic phosphor is in the range from 300 nm to 500 nm, and the second peak light emission wavelength is in the range from 650 nm to 1000 nm, even more preferably the first peak wavelength of light emitted from the inorganic phosphor is in the range from 350 nm to 500 nm, and the second peak light emission wavelength is in the range from 650 nm to 800 nm, furthermore preferably the first peak wavelength of light emitted from the inorganic phosphor is in the range from 400 nm to 500 nm, and the second peak light emission wavelength is in the range from 650 nm to 750 nm, much more preferably the first peak wavelength of light emitted from the inorganic phosphor is in the range from 420 nm to 480 nm, and the second peak light emission wavelength is in the range from 660 nm to 740 nm, the most preferably the first peak wavelength of light emitted from the inorganic phosphor is in the rage from 430 nm to 460 nm and the second peak wavelength of light emitted from the inorganic phosphor is in the range from 660 nm to 710 nm,

and a matrix material.

In another aspect, the invention relates to a formulation comprising, essentially consisting of, or a consisting of the composition and a solvent.

In another aspect, the invention relates to an optical medium (100) comprising the composition.

In another aspect, the invention relates to an optical device (300) comprising the optical medium (100), or the composition and further comprising a light source, a light re-directing device, and/or a reflector.

In another aspect, the invention relates to use of the composition, or the formulation in an optical medium fabrication process.

In another aspect, the present invention furthermore relates to method for preparing the optical medium (100), wherein the method comprises following steps (a) and (b),

(a) providing the composition, or the formulation in a first shaping, preferably providing the composition onto a substrate or into an inflation moulding machine, and

(b) fixing the matrix material by evaporating a solvent and/or polymerizing the composition by heat treatment, or exposing the photosensitive composition under ray of light or a combination of any of these.

In another aspect, the present invention also relates to a light emitting phosphor represented by following general formula (VII),

A₅P₆O₂₅:Mn (VII)

wherein the component “A” stands for at least one cation selected from the group consisting of Si⁴⁺, Ge⁴⁺, Sn⁴⁺, Ti⁴⁺ and Zr⁴⁺, preferably Mn is Mn⁴⁺, more preferably said phosphor is Si₅P₆O₂₅:Mn⁴⁺.

In another aspect, the present invention also relates to a light emitting phosphor represented by following general formula (IX), or (X)

A¹₂B¹C¹O₆:Mn (IX)
A¹=at least one cation selected from the group consisting of Mg²⁺, Ca²⁺, Sr²⁺ and Ba²⁺ Zn²⁺, preferably A¹ is Ba²⁺;
B¹=at least one cation selected from the group consisting of Sc³⁺, Y³⁺, La³⁺, Ce³⁺, B³⁺, Al³⁺ and Ga³⁺, preferably B¹ is Y³⁺;
C¹=at least one cation selected from the group consisting of V⁵⁺, Nb⁵⁺ and Ta⁵⁺, preferably C¹ is Ta⁵⁺;

A²B²C²D¹O₆:Mn (X)
A²=at least one cation selected from the group consisting of Li⁺, Na⁺, K⁺, Rb⁺ and Cs⁺, preferably A² is Na⁺;
B²=at least one cation selected from the group consisting of Sc³⁺, La³⁺, Ce³⁺, B³⁺, Al³⁺ and Ga³⁺, preferably B² is La³⁺;
C²=at least one cation selected from the group consisting of Mg²⁺, Ca²⁺, Sr²⁺, Ba²⁺ and Zn²⁺, preferably C² is Mg²⁺;
D¹=at least one cation selected from the group consisting of Mo⁶⁺ and W⁶⁺, preferably D¹ is W⁶⁺.

In another aspect, the present invention relates to use of the composition, the formulation, the optical medium (100), the optical device (200), or the phosphor, for agriculture or for cultivation of algas, photosynthetic bacterias, and/or phytoplanktons.

in another aspect, the present invention relates to use of the composition, the formulation, the optical medium (100), the optical device (200), or the phosphor,

for improvement of controlling property of a phytoplankton condition, photosynthetic bacteria and/or alga, preferably acceleration of growth of phytoplankton, photosynthetic bacteria and/or alga; improvement of controlling property of plant condition, preferably controlling of a plant height; controlling of color of fruits; promotion and inhibition of germination; controlling of synthesis of chlorophyll and carotenoids, preferably by blue light; plant growth promotion; adjustment and/or acceleration of flowering time of plants; controlling of production of plant components, such as increasing production amount, controlling of polyphenols content, sugar content, vitamin content of plants; controlling of secondary metabolites, preferably controlling of polyphenols, and/or anthocyanins; controlling of a disease resistance of plants; controlling of ripening of fruits, or controlling of weight of plant.

In another aspect, the present invention relates to use of an inorganic phosphor having a peak wavelength of light emitted from the inorganic phosphor in the range of 650 nm or more, preferably in the range from 650 to 1500 nm, more preferably in the range from 650 to 1000 nm, even more preferably in the range from 650 to 800 nm, furthermore preferably in the range from 650 to 750 nm, much more preferably it is from 660 nm to 730 nm, furthermore preferably it is from 660 nm to 710 nm, the most preferably from 670 nm to 71 nm,

and/or at least one inorganic phosphor having a peak wavelength of light emitted from the inorganic phosphor in the range of 500 nm or less, preferably in the range from 250 nm to 500 nm, more preferably in the range from 300 nm to 500 nm, even more preferably in the range from 350 nm to 500 nm, furthermore preferably in the range from 400 nm to 500 nm, much more preferably in the range from 420 nm to 480 nm, the most preferably in the rage from 430 nm to 460 nm,

and/or at least one inorganic phosphor having a first peak wavelength of light emitted from the inorganic phosphor in the range of 500 nm or less, and a second peak wavelength of light emitted from the inorganic phosphor in the range of 650 nm or more, preferably the first peak wavelength of light emitted from the inorganic phosphor is in the range from 250 nm to 500 nm, and the second peak light emission wavelength is in the range from 650 nm to 1500 nm, more preferably the first peak wavelength of light emitted from the inorganic phosphor is in the range from 300 nm to 500 nm, and the second peak light emission wavelength is in the range from 650 nm to 1000 nm, even more preferably the first peak wavelength of light emitted from the inorganic phosphor is in the range from 350 nm to 500 nm, and the second peak light emission wavelength is in the range from 650 nm to 800 nm, furthermore preferably the first peak wavelength of light emitted from the inorganic phosphor is in the range from 400 nm to 500 nm, and the second peak light emission wavelength is in the range from 650 nm to 750 nm, much more preferably the first peak wavelength of light emitted from the inorganic phosphor is in the range from 420 nm to 480 nm, and the second peak light emission wavelength is in the range from 660 nm to 740 nm, the most preferably the first peak wavelength of light emitted from the inorganic phosphor is in the rage from 430 nm to 460 nm and the second peak wavelength of light emitted from the inorganic phosphor is in the range from 660 nm to 710 nm,

for agriculture, or for cultivation of algas, photosynthetic bacterias, and/or phytoplanktons.

In another aspect, the present invention relates to use of an inorganic phosphor having a peak wavelength of light emitted from the inorganic phosphor in the range of 650 nm or more, preferably in the range from 650 to 1500 nm, more preferably in the range from 650 to 1000 nm, even more preferably in the range from 650 to 800 nm, furthermore preferably in the range from 650 to 750 nm, much more preferably it is from 660 nm to 730 nm, furthermore preferably it is from 660 nm to 710 nm, the most preferably from 670 nm to 710 nm,

and/or at least one inorganic phosphor having a peak wavelength of light emitted from the inorganic phosphor in the range of 500 nm or less, preferably in the range from 250 nm to 500 nm, more preferably in the range from 300 nm to 500 nm, even more preferably in the range from 350 nm to 500 nm, furthermore preferably in the range from 400 nm to 500 nm, much more preferably in the range from 420 nm to 480 nm, the most preferably in the rage from 430 nm to 460 nm,

and/or at least one inorganic phosphor having a first peak wavelength of light emitted from the inorganic phosphor in the range of 500 nm or less, and a second peak wavelength of light emitted from the inorganic phosphor in the range of 650 nm or more, preferably the first peak wavelength of light emitted from the inorganic phosphor is in the range from 250 nm to 500 nm, and the second peak light emission wavelength is in the range from 650 nm to 1500 nm, more preferably the first peak wavelength of light emitted from the inorganic phosphor is in the range from 300 nm to 500 nm, and the second peak light emission wavelength is in the range from 650 nm to 1000 nm, even more preferably the first peak wavelength of light emitted from the inorganic phosphor is in the range from 350 nm to 500 nm, and the second peak light emission wavelength is in the range from 650 nm to 800 nm, furthermore preferably the first peak wavelength of light emitted from the inorganic phosphor is in the range from 400 nm to 500 nm, and the second peak light emission wavelength is in the range from 650 nm to 750 nm, much more preferably the first peak wavelength of light emitted from the inorganic phosphor is in the range from 420 nm to 480 nm, and the second peak light emission wavelength is in the range from 660 nm to 740 nm, the most preferably the first peak wavelength of light emitted from the inorganic phosphor is in the rage from 430 nm to 460 nm and the second peak wavelength of light emitted from the inorganic phosphor is in the range from 660 nm to 710 nm,

for improvement of controlling property of a phytoplankton condition, photosynthetic bacteria and/or alga, preferably acceleration of growth of phytoplankton, photosynthetic bacteria and/or alga; improvement of controlling property of plant condition, preferably controlling of a plant height; controlling of color of fruits; promotion and inhibition of germination; controlling of synthesis of chlorophyll and carotenoids, preferably by blue light; plant growth promotion; adjustment and/or acceleration of flowering time of plants; controlling of production of plant components, such as increasing production amount, controlling of polyphenols content, sugar content, vitamin content of plants; controlling of secondary metabolites, preferably controlling of polyphenols, and/or anthocyanins; controlling of a disease resistance of plants; controlling of ripening of fruits, or controlling of weight of plant.

In another aspect, the present invention furthermore relates to method comprising at least applying the formulation, to at least one portion of a plant.

In another aspect, the present invention furthermore relates to modulating a condition of a plant, comprising at least following step (C),

(C) providing the optical medium (100), between a light source and a plant, between a light source and a plankton, preferably said plankton is a phytoplankton, or between a light source and a bacterium, preferably said bacterium is a photosynthetic bacterium, or

providing the optical medium (100), over a ridge in a field or over a surface of planter, preferably said planter is a nutrient film technique hydroponics system or a deep flow technique hydroponics system to control plant growth.

In another aspect, the present invention also relates to method for preparing the optical device (200), wherein the method comprises following step (A);

(A) providing the optical medium (100) in an optical device (200).

In another aspect, the present invention further relates to a plant obtained or obtainable by the method, or a plankton obtained or obtainable by the method, or a bacterium obtained or obtainable by the method.

In another aspect, the present invention furthermore relates to a container comprising at least one plant, one plankton, and/or a bacterium.

Further advantages of the present invention will become evident from the following detailed description.

### DESCRIPTION OF DRAWINGS

FIG. 1: shows a cross sectional view of a schematic of one embodiment of an optical medium (100) of the invention.

FIG. 2: shows a cross sectional view of a schematic of one embodiment of an optical device (200) of the invention.

FIG. 3: shows a cross sectional view of a schematic of another embodiment of an optical device of the invention.

FIG. 4: shows a schematic of another embodiment of an optical device of the invention.

FIG. 5: shows the excitation and emission spectra of Ba₂YTaO₆:Mn⁴⁺ of working example 3.

FIG. 6: shows the excitation and emission spectra of NaLaMgWO₆:Mn⁴⁺ of working example 4.

FIG. 7: shows the excitation and emission spectra of Si₅P₆O₂₅:Mn⁴⁺ of working example 5.

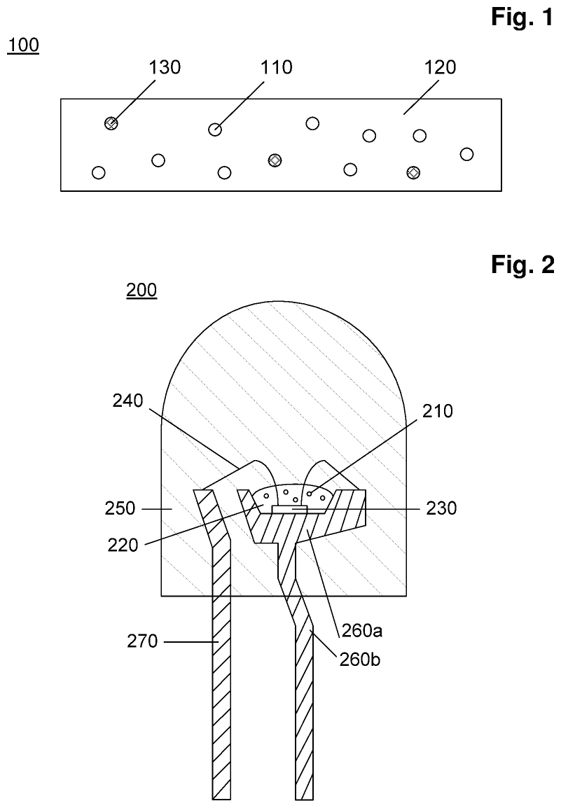

### LIST OF REFERENCE SIGNS IN FIG. 1

100. an optical medium (a color conversion sheet)
110. an inorganic phosphor of the invention
120. a matrix material
130. an additive (optional)

### LIST OF REFERENCE SIGNS IN FIG. 2

200. an optical device (a light emitting diode device)
210. an inorganic phosphor of the invention
220. a matrix material
230. a light emitting diode element
240. conductive wires
250. a molding Material
260a. a cup
260b. a mount lead
270. an inner lead

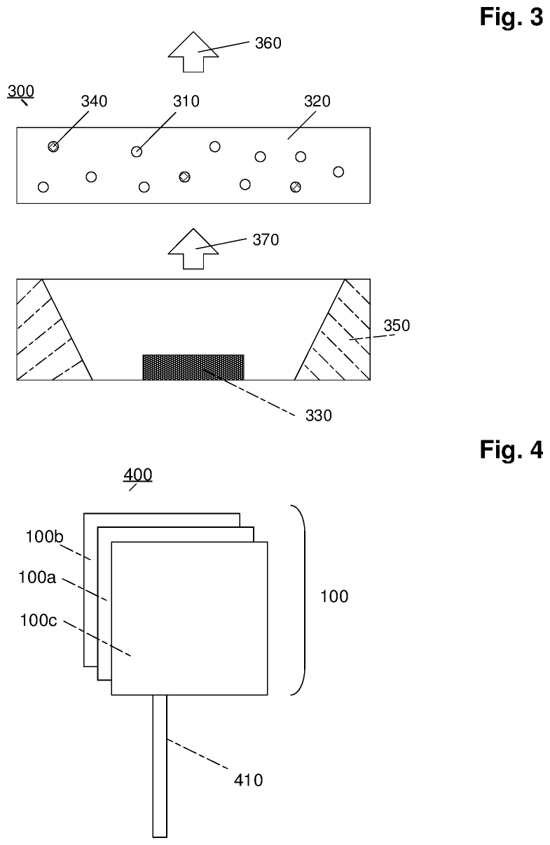

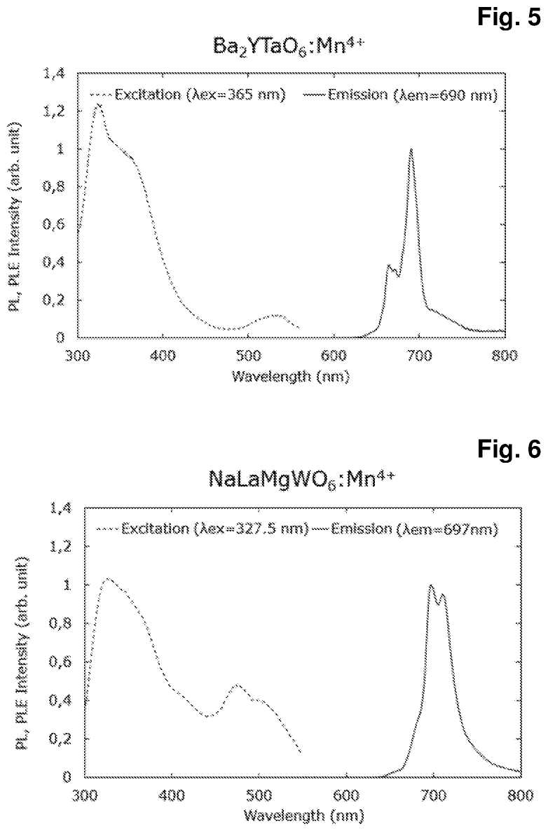

### LIST OF REFERENCE SIGNS IN FIG. 3

300. a light emitting diode device
301. a color conversion sheet
310. an inorganic phosphor of the invention
320. a matrix material
330. a light emitting diode element
340. an additive (optional)
350. a casing
360. converted light
370. emitted light

### LIST OF REFERENCE SIGNS IN FIG. 4

400. an optical device
100. an optical medium
100a. a first layer of the optical medium
100b. a second layer of the optical medium (optional)
100c. a third layer of the optical medium (optional)
410. a supporting part

### Definitions

The above outlines and the following details are for describing the present invention, and are not for limiting the claimed invention. Unless otherwise stated, the following terms used in the specification and claims shall have the following meanings for this Application.

In this application, the use of the singular includes the plural, and the words “a”, “an” and “the” mean “at least one”, unless specifically stated otherwise. In this specification, when one concept component can be exhibited by plural species, and when its amount (e.g. weight %, mol %) is described, the amount means the total amount of them, unless specifically stated otherwise.

Furthermore, the use of the term “including”, as well as other forms such as “includes” and “included”, is not limiting. Also, terms such as “element” or “component” encompass both elements or components comprising one unit and elements or components that comprise more than one unit, unless specifically stated otherwise. As used herein, the term “and/or” refers to any combination of the elements including using a single element.

In the present specification, when the numerical range is shown using “to”, “-” or “˜”, the numerical range includes both numbers before and after the “to”, “-” or “˜”, and the unit is common for the both numbers, unless otherwise specified. For example, 5 to 25 mol % means 5 mol % or more and 25 mol % or less.

The section headings used herein are for organizational purposes and are not to be construed as limiting the subject matter described. All documents, or portions of documents, cited in this application, including, but not limited to, patents, patent applications, articles, books, and treatises, are hereby expressly incorporated herein by reference in their entirety for any purpose. If one or more of the incorporated literature and similar materials defines a term in a manner that contradicts the definition of that term in this application, this application controls.

The term “fluorescent” covers any possible emission based on electronic transitions, singlet, triplet, quintet transitions. preferably is defined as the physical process of light emission by a substance that has absorbed light or other electromagnetic radiation. It is a form of luminescence. In most cases, the emitted light has a longer wavelength, and therefore lower energy, than the absorbed radiation.

The term “emission” means the emission of electromagnetic waves by electron transitions in atoms and molecules.

### DETAILED DESCRIPTION OF THE INVENTION

Composition

According to the present invention, said composition comprises, essentially consists of, or a consists of at least one inorganic phosphor having a peak wavelength of light emitted from the inorganic phosphor in the range of 650 nm or more, preferably in the range from 650 to 1500 nm, more preferably in the range from 650 to 1000 nm, even more preferably in the range from 650 to 800 nm, furthermore preferably in the range from 650 to 750 nm, much more preferably it is from 660 nm to 730 nm, furthermore preferably it is from 660 nm to 710 nm, the most preferably from 670 nm to 710 nm,

and/or at least one inorganic phosphor having a peak wavelength of light emitted from the inorganic phosphor in the range of 500 nm or less, preferably in the range from 250 nm to 500 nm, more preferably in the range from 300 nm to 500 nm, even more preferably in the range from 350 nm to 500 nm, furthermore preferably in the range from 400 nm to 500 nm, much more preferably in the range from 420 nm to 480 nm, the most preferably in the rage from 430 nm to 460 nm,

and/or at least one inorganic phosphor having a first peak wavelength of light emitted from the inorganic phosphor in the range of 500 nm or less, and a second peak wavelength of light emitted from the inorganic phosphor in the range of 650 nm or more, preferably the first peak wavelength of light emitted from the inorganic phosphor is in the range from 250 nm to 500 nm, and the second peak light emission wavelength is in the range from 650 nm to 1500 nm, more preferably the first peak wavelength of light emitted from the inorganic phosphor is in the range from 300 nm to 500 nm, and the second peak light emission wavelength is in the range from 650 nm to 1000 nm, even more preferably the first peak wavelength of light emitted from the inorganic phosphor is in the range from 350 nm to 500 nm, and the second peak light emission wavelength is in the range from 650 nm to 800 nm, furthermore preferably the first peak wavelength of light emitted from the inorganic phosphor is in the range from 400 nm to 500 nm, and the second peak light emission wavelength is in the range from 650 nm to 750 nm, much more preferably the first peak wavelength of light emitted from the inorganic phosphor is in the range from 420 nm to 480 nm, and the second peak light emission wavelength is in the range from 660 nm to 740 nm, the most preferably the first peak wavelength of light emitted from the inorganic phosphor is in the rage from 430 nm to 460 nm and the second peak wavelength of light emitted from the inorganic phosphor is in the range from 660 nm to 710 nm,

and a matrix material.

According to the present invention the term peak wavelength comprises both the main peak of an emission/absorption spectrum having maximum intensity/absorption and side peaks having smaller intensity/absorption than the main peak.

Preferably, the term peak wavelength is related to a side peak.

Preferably, the term peak wavelength is related to the main peak having maximum intensity/absorption.

Preferably, the composition comprises a plurality of inorganic phosphors having a peak wavelength of light emitted from the inorganic phosphor in the range of 650 nm or more, preferably in the range from 650 to 1500 nm, more preferably in the range from 650 to 1000 nm, even more preferably in the range from 650 to 800 nm, furthermore preferably in the range from 650 to 750 nm, much more preferably it is from 660 nm to 730 nm, furthermore preferably it is from 660 nm to 710 nm, the most preferably from 670 nm to 710 nm,

and/or at least one inorganic phosphor having a peak wavelength of light emitted from the inorganic phosphor in the range of 500 nm or less, preferably in the range from 250 nm to 500 nm, more preferably in the range from 300 nm to 500 nm, even more preferably in the range from 350 nm to 500 nm, furthermore preferably in the range from 400 nm to 500 nm, much more preferably in the range from 420 nm to 480 nm, the most preferably in the rage from 430 nm to 460 nm,

and/or at least one inorganic phosphor having a first peak wavelength of light emitted from the inorganic phosphor in the range of 500 nm or less, and a second peak wavelength of light emitted from the inorganic phosphor in the range of 650 nm or more, preferably the first peak wavelength of light emitted from the inorganic phosphor is in the range from 250 nm to 500 nm, and the second peak light emission wavelength is in the range from 650 nm to 1500 nm, more preferably the first peak wavelength of light emitted from the inorganic phosphor is in the range from 300 nm to 500 nm, and the second peak light emission wavelength is in the range from 650 nm to 1000 nm, even more preferably the first peak wavelength of light emitted from the inorganic phosphor is in the range from 350 nm to 500 nm, and the second peak light emission wavelength is in the range from 650 nm to 800 nm, furthermore preferably the first peak wavelength of light emitted from the inorganic phosphor is in the range from 400 nm to 500 nm, and the second peak light emission wavelength is in the range from 650 nm to 750 nm, much more preferably the first peak wavelength of light emitted from the inorganic phosphor is in the range from 420 nm to 480 nm, and the second peak light emission wavelength is in the range from 660 nm to 740 nm, the most preferably the first peak wavelength of light emitted from the inorganic phosphor is in the rage from 430 nm to 460 nm and the second peak wavelength of light emitted from the inorganic phosphor is in the range from 660 nm to 710 nm,

and a matrix material.

Inorganic Phosphors

According to the present invention, any type of publicly known inorganic phosphors having a peak wavelength of light emitted from the inorganic phosphor in the range of 650 nm or more, preferably in the range from 650 to 1500 nm, more preferably in the range from 650 to 1000 nm, even more preferably in the range from 650 to 800 nm, furthermore preferably in the range from 650 to 750 nm, much more preferably it is from 660 nm to 730 nm, furthermore preferably it is from 660 nm to 710 nm, the most preferably from 670 nm to 71 nm,

and/or at least one inorganic phosphor having a peak wavelength of light emitted from the inorganic phosphor in the range of 500 nm or less, preferably in the range from 250 nm to 500 nm, more preferably in the range from 300 nm to 500 nm, even more preferably in the range from 350 nm to 500 nm, furthermore preferably in the range from 400 nm to 500 nm, much more preferably in the range from 420 nm to 480 nm, the most preferably in the rage from 430 nm to 460 nm,

and/or at least one inorganic phosphor having a first peak wavelength of light emitted from the inorganic phosphor in the range of 500 nm or less, and a second peak wavelength of light emitted from the inorganic phosphor in the range of 650 nm or more, preferably the first peak wavelength of light emitted from the inorganic phosphor is in the range from 250 nm to 500 nm, and the second peak light emission wavelength is in the range from 650 nm to 1500 nm, more preferably the first peak wavelength of light emitted from the inorganic phosphor is in the range from 300 nm to 500 nm, and the second peak light emission wavelength is in the range from 650 nm to 1000 nm, even more preferably the first peak wavelength of light emitted from the inorganic phosphor is in the range from 350 nm to 500 nm, and the second peak light emission wavelength is in the range from 650 nm to 800 nm, furthermore preferably the first peak wavelength of light emitted from the inorganic phosphor is in the range from 400 nm to 500 nm, and the second peak light emission wavelength is in the range from 650 nm to 750 nm, much more preferably the first peak wavelength of light emitted from the inorganic phosphor is in the range from 420 nm to 480 nm, and the second peak light emission wavelength is in the range from 660 nm to 740 nm, the most preferably the first peak wavelength of light emitted from the inorganic phosphor is in the rage from 430 nm to 460 nm and the second peak wavelength of light emitted from the inorganic phosphor is in the range from 660 nm to 710 nm, can be used preferably.

It is believed that the peak light wavelength of the light emitted from the phosphor in the rage 660 nm to 710 nm is specifically useful for plant growth.

As used in the present application, the terms “inorganic phosphor” which are used as synonyms here, denote a fluorescent inorganic material in particle form having one or more emitting centres. The emitting centres are formed by activators, usually atoms or ions of a rare-earth metal element, such as, for example, La, Ce, Pr, Nd, Pm, Sm, Eu, Gd, Tb, Dy, Ho, Er, Tm, Yb and Lu, and/or atoms or ions of a transition-metal element, such as, for example, Cr, Mn, Fe, Co, Ni, Cu, Ag, Au and Zn, and/or atoms or ions of a main-group metal element, such as, for example, Na, Tl, Sn, Pb, Sb and Bi. Examples of phosphors include garnet-based phosphors, silicate-based, orthosilicate-based, thiogallate-based, sulfide-based and nitride-based phosphors. The phosphor materials can be phosphor particles with or without silicon dioxide coating. A phosphor in the sense of the present application is taken to mean a material which absorbs radiation in a certain wavelength range of the electromagnetic spectrum, preferably in the blue or UV spectral range, and emits visible light or far red light in another wavelength range of the electromagnetic spectrum, preferably in the violet, blue, green, yellow, orange, red spectral range or far red spectral range.

The term “radiation-induced emission efficiency” should also be understood in this connection, i.e. the phosphor absorbs radiation in a certain wavelength range and emits radiation in another wavelength range with a certain efficiency. The term “shift of the emission wavelength” is taken to mean that a phosphor emits light at a different wavelength compared with another, i.e. shifted towards a shorter or longer wavelength.

A wide variety of phosphors come into consideration for the present invention, such as, for example, metal-oxide phosphors, silicate and halide phosphors, phosphate and halophosphate phosphors, borate and borosilicate phosphors, aluminate, gallate and alumosilicate phosphors, phosphors, sulfate, sulfide, selenide and telluride phosphors, nitride and oxynitride phosphors and SiAION phosphors.

In some embodiments of the present invention, the phosphor is selected from the group consisting of metal-oxide phosphors, silicate and halide phosphors, phosphate phosphors, borate and borosilicate phosphors, aluminate, gallate and alumosilicate phosphors, sulfate, sulfide, selenide and telluride phosphors, nitride and oxynitride phosphors and SiAION phosphors, preferably, it is a metal oxide phosphor, more preferably it is a Mn activated metal oxide phosphor or a Mn activated phosphate based phosphor, even more preferably it is a Mn activated metal oxide phosphor. Preferred metal-oxide phosphors are arsenates, germanates, halogerman-ates, indates, lanthanates, niobates, scandates, stannates, tantalates, titanates, vanadates, halovanadates, phosphovanadates, yttrates, zirconates, molybdate and tungstate.

Even more preferably, it is a metal oxide phosphor, more preferably it is a Mn activated metal oxide phosphor or a Mn activated phosphate based phosphor, even more preferably it is a Mn activated metal oxide phosphor.

Thus, in some embodiments of the present invention, said inorganic phosphor is selected from the group consisting of metal oxides, silicates and halosilicates, phosphates and halophosphates, borates and borosilicates, aluminates, gallates and alumosilicates, molybdates and tungstates, sulfates, sulfides, selenides and tellurides, nitrides and oxynitrides, SiAIONs, halogen compounds and oxy compounds, such as preferably oxysulfides or oxychlorides phosphors, preferably, it is a metal oxide phosphor, more preferably it is a Mn activated metal oxide phosphor or a Mn activated phosphate based phosphor, even more preferably it is a Mn activated metal oxide phosphor.

For example, the inorganic phosphor is selected from the group consisting of Al₂O₃:Cr^{3+,} Y₃Al₅O₁₂:Cr³⁺, MgO:Cr³⁺, ZnGa₂O₄:Cr³⁺, MgAl₂O₄:Cr³⁺, Gd₃Ga₅O₁₂:Cr³⁺, LiAl₅O₈:Cr³⁺, MgSr₃Si₂O₈:Eu²⁺, Mn²⁺, Sr₃MgSi₂O₈:Mn⁴⁺, Sr₂MgSi₂O₇:Mn⁴⁺, SrMgSi₂O₆:Mn⁴⁺, BaMg₆Ti₆O₁₉:Mn⁴⁺, Ca₁₄Al₁₀Zn₆O₃₅:Mn⁴⁺, Mg₈Ge₂O₁₁F₂:Mn⁴⁺, Mg₂TiO₄:Mn⁴⁺, Y₂MgTiO₆:Mn⁴⁺, Li₂TiO₃:Mn⁴⁺, K₂SiF₆:Mn⁴⁺, K₃SiF₇:Mn⁴⁺, K₂TiF₆:Mn⁴⁺, K₂NaAlF₆:Mn⁴⁺, BaSiF₆:Mn^{4+,} CaAl₁₂O₁₉:Mn⁴⁺, MgSiO₃:Mn²⁺, Si₅P₆O₂₅:Mn⁴⁺, NaLaMgWO₆:Mn⁴⁺, Ba₂YTaO₆:Mn⁴⁺, ZnAl₂O₄:Mn²⁺, CaGa₂S₄:Mn²⁺, CaAlSiN₃:Eu²⁺, SrAlSiN₃:Eu²⁺, Sr₂Si₅N₈:Eu²⁺, SrLiAlN₄:Eu²⁺, CaMgSi₂O₆:Eu²⁺, Sr₂MgSi₂O₇:Eu²⁺, SrBaMgSi₂O₇:Eu²⁺, Ba₃MgSi₂O₈:Eu²⁺, LiSrPO₄:Eu²⁺, LiCaPO₄:Eu²⁺, NaSrPO₄:Eu²⁺, KBaPO₄:Eu²⁺, KSrPO₄:Eu²⁺, KMgPO₄:Eu²⁺, α-Sr₂P₂O₇:Eu²⁺, α-Ca₂P₂O₇:Eu²⁺, Mg₃(PO₄)₂:Eu²⁺, Mg₃Ca₃(PO₄)₄:Eu²⁺, BaMgAl₁₀O₁₇:Eu²⁺, SrMgAl₁₀O₁₇:Eu²⁺, AlN:Eu²⁺, Sr₅(PO₄)₃Cl:Eu²⁺, NaMgPO₄ (glaserite):Eu²⁺, Na₃Sc₂(PO₄)₃:Eu²⁺, LiBaBO₃:Eu²⁺, SrAlSi₄N₇:Eu²⁺, Ca₂SiO₄:Eu²⁺, NaMgPO₄:Eu²⁺, CaS:Eu²⁺, Y₂O₃:Eu³⁺, YVO₄:Eu³⁺, LiAlO₂:Fe³⁺, LiAl₅O₈:Fe³⁺, NaAlSiO₄:Fe³⁺, MgO:Fe³⁺, Gd₃Ga₅O₁₂:Cr³⁺,Ce³⁺, (Ca, Ba, Sr)₂MgSi₂O₇:Eu,Mn, CaMgSi₂O₅:Eu²⁺,Mn²⁺, NaSrBO₃:Ce³⁺, NaCaBO₃:Ce³⁺, Ca₃(BO₃)₂:Ce³⁺, Sr₃(BO₃)₂:Ce³⁺, Ca₃Y(GaO)₃(BO₃)₄:Ce³⁺, Ba₃Y(BO₃)₃:Ce³⁺, CaYAlO₄:Ce³⁺, Y₂SiO₅:Ce³⁺, YSiO₂N:Ce³⁺, Y₅(SiO₄)₃N:Ce³⁺, Ca₂Al₃O₆FGd₃Ga₅O₁₂:Cr³⁺,Ce³⁺, ZnS, InP/ZnS, CuInS₂, CuInSe₂, CuInS₂/ZnS, carbon/graphen quantum dots and a combination of any of these as described in the second chapter of Phosphor handbook (Yen, Shinoya, Yamamoto).

As one embodiment of the invention, a phosphor or its denaturated (e.g., degraded) substance which less harms animals, plants and/or environment (e.g., soil, water) is desirable.

Thus, one embodiment of the invention, the phosphor is nontoxic phosphors, preferably it is edible phosphors, more preferably as edible phosphors, MgSiO₃:Mn²⁺, MgO:Fe³⁺, CaMgSi₂O₆:Eu²⁺, Mn² are useful.

According to the present invention the term “edible” means safe to eat, fit to eat, fit to be eaten, fit for human consumption.

In some embodiments, as a phosphate based phosphor, a new light emitting phosphor represented by following general formula (VII) which can exhibit deep red-light emission, preferably with a sharp emission around 700 nm under excitation light of 300 to 400 nm, which are suitable to promote plant growth, can be used preferably.

A₅P₆O₂₅:Mn (VII)

wherein the component “A” stands for at least one cation selected from the group consisting of Si⁴⁺, Ge⁴⁺, Sn⁴⁺, Ti⁴⁺ and Zr⁴⁺.

Or the phosphor can be represented by following chemical formula (VII′).

(A₁₋ₓMnₓ)₅P₆O₂₅ (VII′)

The component A stands for at least one cation selected from the group consisting of Si⁴⁺, Ge⁴⁺, Sn⁴⁺, Ti⁴⁺ and Zr⁴⁺, preferably A is Si⁴+; 0<x≤0.5, preferably 0.05<x≤0.4.

In a preferred embodiment of the present invention, Mn of formula (VII) is Mn4⁺.

In a preferred embodiment of the present invention, the phosphor represented by chemical formula is Si₅P₆O₂₅:Mn⁴⁺.

Said phosphor represented by chemical formula (VII) or (VII′) can be fabricated by the following method comprising at least the following steps (w) and (x);

(w) mixing a source of the component A in the form of an oxide, and a source of the activator selected from one or more members of the group consisting of MnO₂, MnO, MnCO₃, Mn(OH)₂, MnSO₄, Mn(NO₃)₂, MnCl₂, MnF₂, Mn(CH₃COO)₂ and hydrates of MnO₂, MnO, MnCO₃, Mn(OH)₂, MnSO₄, Mn(NO₃)₂, MnCl₂, MnF₂, Mn(CH₃COO)₂;

and at least one material selected from the group consisting of inorganic alkali, alkaline-earth, ammonium phosphate and hydrogen phosphate, preferably the materials is ammonium dihydrogen phosphate, in a molar ratio of A:Mn:P=5x:5(1−x): 6, wherein 0<x≤0.5, preferably 0.01<x≤0.4; more preferably 0.05<x≤0.1, to get a reaction mixture,

(x) subjecting said mixture(s) to calcination at the temperature in the range from 600 to 1.500° C., preferably in the range from 800 to 1.200° C., more preferably in the range from 900 to 1.100° C.

As a mixer, any publicly known powder mixing machine can be used preferably in step (w).

In a preferred embodiment of the present invention, said calcination step (x) is carried out under atmospheric pressure in the presence of oxygen, more preferably under air condition.

In a preferred embodiment of the present invention, said calcination step (x) is carried out for the time at least one hour, preferably in the range from 1 hour to 48 hours, more preferably it is from 6 hours to 24 hours, even more preferably from 10 hours to 15 hours.

After the time period of step (X), the calcinated mixture is cooled down to room temperature.

In a preferred embodiment of the present invention, a solvent is added in step (w) to get a better mixture condition. Preferably said solvent is an organic solvent, more preferably it is selected from one or more members of the group consisting of alcohols such as ethanol, methanol, ipropan-2-ol, butan-1-ol; ketones such as acetone, 2-hexanone, butanone, ethyl isopropyl ketone.

In a preferred embodiment of the present invention, the method further comprises following step (y) after step (w) before step (x):

(y) subjecting the mixture from step (w) to pre-calcination at the temperature in the range from 100 to 500° C., preferably in the range from 200 to 400° C., even more preferably from 250 to 350° C.

Preferably it is carried out under atmospheric pressure and in the presence of oxygen, more preferably under air condition.

In a preferred embodiment of the present invention, said calcination step (y) is carried out for the time at least 1 hour, preferably from 1 hour to 24 hours, more preferably in the range from 1 hour to 15 hours, even more preferably it is from 3 hours to 10 hours, furthermore preferably from 5 hours to 8 hours.

After the time period, pre-calcinated mixture is cooled down to a room temperature preferably.

In a preferred embodiment of the present invention, the method additionally comprises following step (w′) after pre-calcination step (y),

(w′) mixing a mixture obtained from step (y) to get a better mixing condition of the mixture.

As a mixer, any publicly known powder mixing machine can be used preferably in step (w′).

In a preferred embodiment of the present invention, the method further comprises following step (z) before step (x) after step (w), preferably after step (w′),

(z) molding said mixture from step (w) or (y) into a compression molded body by a molding apparatus.

In a preferred embodiment of the present invention, the method optionally comprises following step (v) after step (x),

(v) grinding obtained material.

As a molding apparatus, a publicly known molding apparatus can be used preferably.

In some embodiments, as a metal oxide phosphor, another new light emitting phosphor represented by following general formula (VIII), (IX) or (X) which can exhibit deep red-light emission, preferably with a sharp emission around 700 nm under excitation light of 300 to 400 nm, which are suitable to promote plant growth, can be used preferably.

XO₆ (VIII)

where X=(A¹)₂B¹(C¹₍₁₋ₓ₎ Mn⁴⁺_{5/4x}), or X=A²B²C²(D¹_{(1-y)} Mn⁴⁺_{1.5y}), 0<x≤0.5, 0<y≤0.5;

A¹₂B¹C¹O₆:Mn (IX)

A²B²C²D¹O₆:Mn (X)
A¹=at least one cation selected from the group consisting of Mg²⁺, Ca²⁺, Sr²⁺ and Ba²⁺ Zn²⁺, preferably A¹ is Ba²⁺;
B¹=at least one cation selected from the group consisting of Sc³⁺, Y³⁺, La³⁺, Ce³⁺, B³⁺, Al³⁺ and Ga³⁺, preferably B¹ is Y³⁺;
C¹=at least one cation selected from the group consisting of V⁵⁺, Nb⁵⁺ and Ta⁵⁺, preferably C¹ is Ta⁵⁺;
A²=at least one cation selected from the group consisting of Li⁺, Na⁺, K⁺, Rb⁺ and Cs⁺, preferably A² is Na⁺;
B²=at least one cation selected from the group consisting of Sc³⁺, La³⁺, Ce³⁺, B³⁺, Al³⁺ and Ga³⁺, preferably B² is La³⁺;
C²=at least one cation selected from the group consisting of Mg²⁺, Ca²⁺, Sr²⁺, Ba²⁺ and Zn²⁺, preferably C² is Mg²⁺;
D¹=at least one cation selected from the group consisting of Mo⁶⁺ and W⁶⁺, preferably D¹ is W⁶⁺.

In a preferred embodiment of the present invention, Mn is Mn⁴⁺, more preferably, the phosphor represented by chemical formula (X) is NaLaMgWO₆:Mn⁴⁺ and the phosphor represented by chemical formula (IX) Ba₂YTaO₆:Mn⁴⁺.

Said phosphor represented by chemical formula (VIII) or (IX) can be fabricated by the following method comprising at least the following steps (w″) and (x′);

(w″) mixing sources of components A¹, B¹, C¹, or A², B², C², and D¹ in the form of solid oxides and/or carbonates;

and a source of Mn activator selected from one or more members of the group consisting of MnO₂, MnO, MnCO₃, Mn(OH)₂, MnSO₄, Mn(NO₃)₂, MnCl₂, MnF₂, Mn(CH₃COO)₂ and hydrates of MnO₂, MnO, MnCO₃, Mn(OH)₂, MnSO₄, Mn(NO₃)₂, MnCl₂, MnF₂, Mn(CH₃COO)₂;

in a molar ratio of either

A¹:B¹:C¹:Mn=2:1:(1−x):x or

A²:B²:C²:D¹:Mn=1:1:1:(1−y):y(0<y≤0.5);

wherein 0<x≤0.5, 0<y≤0.5, preferably 0.01<x≤0.4, 0.01<y≤0.4; more preferably 0.05<x≤0.1, 0.05<y≤0.1; to get a reaction mixture,

(x′) subjecting said mixture to calcination at the temperature in the range from 1,000 to 1,600° C., preferably in the range from 1,100 to 1,500° C., more preferably in the range from 1,200 to 1,400° C.

Preferably, when preparing phosphors according to general formula (IX) mixtures are preferred comprising component A¹ in the form of their oxides (MgO, ZnO) or carbonates (CaCO₃, SrCO₃, BaCO₃), and the remaining components B¹, C¹ an Mn in the form of their oxides (Sc₂O₃, Y₂O₃, La₂O₃, Ce₂O₃, B₂O₃, Al₂O₃, Ga₂O₃ on one hand and V₂O₅, Nb₂O₅, Ta₂O₅ and MnO₂ on the other). In case of lanthanum oxide, it is advantageous to pre-heat the material at 1.200° C. for 10 hours.

Preferably when preparing phosphors according to general formula (X) mixtures are preferred comprising component A² and C² in the form of their oxides (MgO, ZnO) or carbonates (Li₂CO₃, Na₂CO₃, K₂CO₃, Rb₂CO₃, Cs₂CO₃, CaCO₃, SrCO₃, BaCO₃), and the remaining components B², D² and Mn in the form of their oxides (Sc₂O₃, La₂O₃, Ce₂O₃, B₂O₃, Al₂O₃, Ga₂O₃ on one hand and MoO₃, WO₃ and MnO₂ on the other).

As a mixer, any publicly known powder mixing machine can be used preferably in step (w).

In a preferred embodiment of the present invention, said calcination step (x′) is carried out under atmospheric pressure in the presence of oxygen, more preferably under air condition.

In a preferred embodiment of the present invention, said calcination step (x′) is carried out for the time at least one hour, preferably in the range from 1 hour to 48 hours, more preferably it is from 6 hours to 24 hours, even more preferably from 10 hours to 15 hours.

After the time period of step (x′), the calcinated mixture is cooled down to room temperature.

In a preferred embodiment of the present invention, a solvent is added in step (w″) to get a better mixture condition. Preferably said solvent is an organic solvent, more preferably it is selected from one or more members of the group consisting of alcohols such as ethanol, methanol, ipropan-2-ol, butan-1-ol; ketones such as acetone, 2-hexanone, butanone, ethyl isopropyl ketone.

In a preferred embodiment of the present invention, the method further comprises following step (y′) after step (w″) before step (x′):

(y′) subjecting the mixture from step (w″) to pre-calcination at the temperature in the range from 100 to 500° C., preferably in the range from 200 to 400° C., even more preferably from 250 to 350° C.

Preferably it is carried out under atmospheric pressure and in the presence of oxygen, more preferably under air condition.

In a preferred embodiment of the present invention, said calcination step (y′) is carried out for the time at least 1 hour, preferably from 1 hour to 24 hours, more preferably in the range from 1 hour to 15 hours, even more preferably it is from 3 hours to 10 hours, furthermore preferably from 5 hours to 8 hours.

After the time period, pre-calcinated mixture is cooled down to a room temperature preferably.

In a preferred embodiment of the present invention, the method additionally comprises following step (w′″) after pre-calcination step (y′), (w′″) mixing a mixture obtained from step (y′) to get a better mixing condition of the mixture.

As a mixer, any publicly known powder mixing machine can be used preferably in step (w′″).

In a preferred embodiment of the present invention, the method further comprises following step (z′) before step (x′) after step (w″), preferably after step (w′″),

(z′) molding said mixture from step (w) or (y) into a compression molded body by a molding apparatus.

In a preferred embodiment of the present invention, the method optionally comprises following step (v′) after step (x′),

(v′) grinding obtained material.

As a molding apparatus, a publicly known molding apparatus can be used preferably.

In some embodiments of the present invention, the inorganic phosphors can emit a light having the peak wavelength of light emitted from the inorganic phosphor in the range from 660 nm to 710 nm.

It is believed that the peak maximum light wavelength of light emitted from the inorganic phosphor in the range from 660 nm to 710 nm is very suitable for plant condition control, especially for plant growth promotion.

Without wishing to be bound by theory, it is believed that the inorganic phosphor having at least one light absorption peak wavelength in UV and/or purple light wavelength region from 300 nm to 430 nm may keep harmful insects off plants.

Therefore, in some embodiments of the present invention, the inorganic phosphor can have at least one light absorption peak wavelength in UV and/or purple light wavelength reason from 300 nm to 430 nm.

In some embodiments of the present invention, from the viewpoint of improved plant growth and improved homogeneous of blue and red (or infrared) light emission from the composition or from the light converting sheet, an inorganic phosphor having a first peak wavelength of light emitted from the inorganic phosphor in the range from 400 nm to 500 nm and a second peak wavelength of light emitted from the inorganic phosphor from 650 nm to 750 nm can be used preferably.

More preferably, the inorganic phosphor having the first peak wavelength of light emitted from the inorganic phosphor is in the range from 430 nm to 490 nm, and the second peak light emission wavelength is in the range from 660 nm to 740 nm, more preferably the first peak wavelength of light emitted from the inorganic phosphor is 450 nm and the second peak wavelength of light emitted from the inorganic phosphor is in the range from 660 nm to 710 nm, is used.

Preferably, said at least one inorganic phosphor is a plurality of inorganic phosphor having the first and second peak wavelength of light emitted from the inorganic phosphor, or a plurality of inorganic phosphor having the first and second peak wavelength of light emitted from the inorganic phosphor, or a combination of these.

It is believed that the Mn⁴⁺ activated metal oxide phosphors, Mn, Eu activated metal oxide phosphors, Mn²⁺ activated metal oxide phosphors, Fe³⁺ activated metal oxide phosphors can be used preferably from the viewpoint of environmental friendly since these phosphors do not create Cr⁶ during synthesis procedure.

Without wishing to be bound by theory, it is believed that the Mn⁴⁺ activated metal oxide phosphors are very useful for plant growth, since it shows narrow full width at half maximum (hereafter “FWHM”) of the light emission, and have the peak absorption wavelength in UV and green wavelength region such as 350 nm and 520 nm, and the emission peak wavelength is in near infrared ray region such as from 650 nm to 730 nm. More preferably, it is from 670 nm to 710 nm.

In other words, without wishing to be bound by theory, it is believed that the Mn⁴⁺ activated metal oxide phosphors can absorb the specific UV light which attracts insects, and green light which does not give any advantage for plant growth, and can convert the absorbed light to longer wavelength in the range from 650 nm to 750 nm, preferably it is from 660 nm to 740 nm, more preferably from 660 nm to 710 nm, even more preferably from 670 nm to 710 nm, which can effectively accelerate plant growth.

From that point of view, even more preferably, the inorganic phosphor can be selected from Mn activated metal oxide phosphors.

In a further preferred embodiment of the present invention, the inorganic phosphor is selected from one or more of Mn activated metal oxide phosphors or Mn activated phosphate based phosphors represented by following formulae (I) to (VI),

AₓB_{y}O_{z}:Mn⁴⁺ (I)

wherein A is a divalent cation and is selected from one or more members of the group consisting of Mg²⁺, Zn²⁺, Cu², CO²⁺, Ni²⁺, Fe²⁺, Ca²⁺, Sr²⁺, Ba²⁺, Mn²⁺, Ce²⁺ and Sn^{2+,} B is a tetravalent cation and is Ti³⁺, Zr³⁺ or a combination of these; x≥1; y≥0; (x+2y)=z, preferably A is selected from one or more members of the group consisting of Mg²⁺, Ca²⁺, Sr²⁺, Ba²⁺, Zn²⁺, B is Ti³⁺, Zr³⁺ or a combination of Ti³⁺ and Zr³⁺, x is 2, y is 1, z is 4, more preferably, formula (I) is Mg₂TiO₄:Mn⁴⁺;

XₐZ_{b}O_{c}:Mn⁴⁺ (II)

wherein X is a monovalent cation and is selected from one or more members of the group consisting of Li⁺, Na⁺, K⁺, Ag⁺ and Cu⁺; Z is a tetravalent cation and is selected from the group consisting of Ti³⁺ and Zr³⁺; b≥0; a≥1; (0.5a+2b)=c, preferably X is Li⁺, Na⁺ or a combination of these, Z is Ti³⁺, Zr³⁺ or a combination of these a is 2, b is 1, c is 3, more preferably formula (II) is Li₂TiO₃:Mn⁴⁺;

D_{d}EₑO_{f}:Mn⁴⁺ (III)

wherein D is a divalent cation and is selected from one or more members of the group consisting of Mg²⁺, Zn²⁺, Cu², Co²⁺, Ni²⁺, Fe²⁺, Ca²⁺ Sr²⁺, Ba²⁺, Mn²⁺, Ce²⁺ and Sn²⁺; E is a trivalent cation and is selected from the group consisting of Al³⁺, Ga³⁺, Lu³⁺, Sc^{3+,} La³⁺ and In³⁺; e≥10; d≥0; (d+1.5e)=f, preferably 0 is Ca²⁺, Sr²⁺, Ba²⁺ or a combination of any of these, E is Al³⁺, Gd³⁺ or a combination of these, d is 1, e is 12, f is 19, more preferably formula (III) is CaAl₁₂O₁₉:Mn⁴⁺;

D_{g}EₕOᵢ:Mn⁴⁺ (IV)

wherein D is a trivalent cation and is selected from one or more members of the group consisting of Al³⁺, Ga³⁺, Lu³⁺, Sc³⁺, La³⁺ and In³⁺; E is a trivalent cation and is selected from the group consisting of Al³⁺, Ga³⁺, Lu³⁺, Sc³⁺, La³⁺ and In³⁺; h≥0; a≥g; (1.5 g+1.5h)=I, preferably D is La³⁺, E is Al³⁺, Gd³⁺ or a combination of these, g is 1, h is 12, i is 19, more preferably formula (IV) is LaAlO₃:Mn⁴⁺;

GⱼJₖLₗOₘ:Mn⁴⁺ (V)

wherein G is a divalent cation and is selected from one or more members of the group consisting of Mg²⁺, Zn²⁺, Cu²⁺, Co²⁺, Ni²⁺, Fe²⁺, Ca²⁺, Sr²⁺, Ba²⁺, Mn²⁺, Ce²⁺ and Sn²⁺; J is a trivalent cation and is selected from the group consisting of Y³⁺, Al³⁺, Ga³⁺, Lu³⁺, Sc³⁺ La³⁺ and In³⁺; L is a trivalent cation and is selected from the group consisting of Al³⁺, Ga³⁺, Lu³⁺, Sc³⁺, La³⁺ and In³⁺; l≥0; k≥0; j≥0; (j+1.5k+1.5l)=m, preferably G is selected from Ca²⁺, Sr²⁺, Ba²⁺ or a combination of any of these, J is Y³⁺, Lu³⁺ or a combination of these, L is Al³⁺, Gd³ or a combination of these, j is 1, k is 1, l is 1, m is 4, more preferably it is CaYAlO₄:Mn⁴⁺;

MₙQₒRₚO:Eu,Mn (VI)

wherein M and Q are divalent cations and are, independently or dependently of each other, selected from one or more members of the group consisting of Mg², Zn²⁺, Cu²⁺, Co²⁺, Ni²⁺, Fe²⁺, Ca²⁺, Mn²⁺, Ce²⁺; R is Ge³⁺, Si³⁺, or a combination of these; n≥1; o≥0; p≥1; (n+o+2.0p)=q, preferably M is Ca²⁺, Q is Mg²⁺, Ca²⁺, Zn²⁺ or a combination of any of these, R is Si³⁺, n is 1, o is 1, p is 2, q is 6, more preferably it is CaMgSi₂O₆:Eu²⁺, Mn²⁺;

A₅P₆O₂₅:Mn⁴⁺ (VII)

wherein the component “A” stands for at least one cation selected from the group consisting of Si⁴⁺, Ge⁴⁺, Sn⁴⁺, Ti⁴⁺ and Zr⁴⁺;

A¹₂B¹C¹O₆:Mn⁴⁺ (IX)
A¹=at least one cation selected from the group consisting of Mg²⁺, Ca²⁺, Sr²⁺ and Ba²⁺ Zn²⁺, preferably A¹ is Ba²⁺;
B¹=at least one cation selected from the group consisting of Sc³⁺, Y³⁺, La³⁺, Ce^{3+,} B^{3+,} Al³⁺ and Ga³⁺, preferably B¹ is Y³⁺;
C¹=at least one cation selected from the group consisting of V⁵⁺, Nb⁵⁺ and Ta⁵⁺, preferably C¹ is Ta⁵⁺; and

A²B²G²D¹O⁶:Mn⁴⁺ (X)
A²=at least one cation selected from the group consisting of Li⁺, Na⁺, K⁺, Rb⁺ and Cs⁺, preferably A² is Na⁺;
B²=at least one cation selected from the group consisting of Sc³⁺, La³⁺, Ce³⁺, B^{3+,} Al³⁺ and Ga³⁺, preferably B² is La³⁺;
C²=at least one cation selected from the group consisting of Mg²⁺, Ca²⁺, Sr²⁺, Ba²⁺ and Zn²⁺, preferably C² is Mg²⁺;
D¹=at least one cation selected from the group consisting of Mo⁶⁺ and W⁶⁺, preferably D¹ is W⁶⁺.

A Mn activated metal oxide phosphor represented chemical formula (VI) is more preferable since it emits a light with a first peak wavelength of light emitted from the inorganic phosphor in the range of 500 nm or less, and a second peak wavelength of light emitted from the inorganic phosphor in the range of 650 nm or more, preferably the first peak wavelength of light emitted from the inorganic phosphor is in the range from 400 nm to 500 nm, and the second peak light emission wavelength is in the range from 650 nm to 750 nm, more preferably the first peak wavelength of light emitted from the inorganic phosphor is in the range from 420 nm to 480 nm, and the second peak light emission wavelength is in the range from 660 nm to 740 nm, even more preferably the first peak wavelength of light emitted from the inorganic phosphor is in the rage from 430 nm to 460 nm and the second peak wavelength of light emitted from the inorganic phosphor is in the range from 660 nm to 710 nm.

In a preferred embodiment of the present invention, said phosphor is a Mn activated metal oxide phosphor or a phosphate based phosphor represented by chemical formula (I), (VII), (IX) or (X).

In some preferred embodiments of the present invention, the inorganic phosphor can be a Mn activated metal oxide phosphor selected from the group consisting of Mg₂TiO₄:Mn⁴⁺, Li₂TiO₃:Mn⁴⁺, CaAl₁₂O₁₉:Mn⁴⁺, LaAlO₃:Mn⁴⁺, CaYAlO₄:Mn⁴⁺, CaMgSi₂O₆:Eu²⁺, Mn²⁺, and a combination of any of these.

In some embodiments of the present invention, the total amount of the phosphor of the composition is in the range from 0.01 wt. % to 30 wt. % based on the total amount of the composition, preferably it is from 0.1 wt. % to 10 wt. %, more preferably from 0.5 wt. % to 5 wt. %, furthermore preferably it is from 1 wt. % to 3 wt. % from the view point of better light conversion property, lower production cost and less production damage of a production machine.

Matrix Materials

According to the present invention, in some embodiments, matrix material is an organic material, and/or an inorganic material, preferably Al₂O₃, fused composition of TeO₂:Na₂Co₃:ZnO:BaCo₃=7:1:1:1, and fused mixture of TeO₂:Na₂CO₃:ZnO:BaCo₃=7:1:1:1 and Al₂O₃ are excluded. Preferably the matrix material is an organic material.

Preferably, the matrix material is an organic oligomer or an organic polymer material, more preferably an organic polymer selected from the group consisting of a transparent photosetting polymer, a thermosetting polymer, a thermoplastic polymer, or a combination of any of these, can be used preferably.

Thus, in some embodiments of the present invention, the matrix material is an organic material, and/or an inorganic material, preferably the matrix material is an organic material, more preferably it is an organic oligomer or an organic polymer material, even more preferably an organic polymer selected from the group consisting of a transparent photosetting polymer, a thermosetting polymer, a thermoplastic polymer, or a combination of any of these.

As organic polymer materials, polysaccharides, polyethylene, polypropylene, polystyrene, polymethyl pentene, polybutene, butadiene styrene, polyvinyl chloride, polystyrene, polymethacrylic styrene, styrene-acrylonitrile, acrylonitrile-butadiene-styrene, polyethylene terephthalate, polymethyl methacrylate, polyphenylene ether, polyacrylonitrile, polyvinyl alcohol, acrylonitrile polycarbonate, polyvinylidene chloride, polycarbonate, polyarmide, polyacetal, polybutylene terephthalate, polytetrafluoroethylene, ethyl vinyl acetate copolymer, ethylene tetrafluorethylen copolymer, polyamide, phenol, melamine, urea, urethane, epoxy, unsaturated polyester, polyallyl sulfone, polyacrylate, hydroxybenzoic acid polyester, polyetherirrmide, polycyclohexylenedimethylene terephthalate, polyethylene naphthalate, polyester carbonate, polylactic acid, phenolic resin, silicone or a combination of any of these can be used preferably.

As the photosetting polymer, several kinds of (meth)acrylates can be used preferably. Such as unsubstituted alkyl-(meth) acrylates, for examples, methyl-acrylate, methyl-methacrylate, ethyl-acrylate, ethyl-methacrylate, butyl-acrylate, butyl-methacrylate, 2-ethylhexyl-acrylate, 2-ethylhexyl-methacrylate; substituted alkyl-(meth)acrylates, for examples, hydroxyl-group, epoxy group, or halogen substituted alkyl-(meth)acrylates; cyclopentenyl(meth)acrylate, tetra-hydro furfuryl-(meth)acrylate, benzyl (meth)acrylate, polyethylene-glycol di-(meth)acrylates.

In view of better coating performance of the composition, sheet strength, and good handling, the matrix material has a weight average molecular weight in the range from 5,000 to 50,000 preferably, more preferably from 10,000 to 30,000.

According to the present invention, the molecular weight Mw is determined by means of GPC (=gel permeation chromatography) against an internal polystyrene standard.

As the thermosetting polymer, publicly known transparent thermosetting polymer can be used preferably. Such as OE6550 (trade mark) series (Dow Corning).

As the thermoplastic polymer, the type of thermoplastic polymer is not particularly limited. For example, natural rubber(refractive index(n)=1.52), poly-isoprene(n=1.52), poly 1,2-butadine(n=1.50), polyisobutene(n=1.51), polybutene(n=1.51), poly-2-heptyl 1,3-butadine(n=1.50), poly-2-t-butyl-1,3-butadine(n=1.51), poly-1,3-butadine(n=1.52), polyoxyethylene(n=1.46), polyoxypropylene(n=1.45), polyvinylethyl ether(n=1.45), polyvinylhexylether(n=1.46), polyvinylbutylether(n=1.46), polyethers, poly vinyl acetate(n=1.47), poly esters, such as poly vinyl propionate(n=1.47), poly urethane(n=1.5 to 1.6), ethyl celullose(n=1.48), poly vinyl chloride(n=1.54 to 1.55), poly acrylo nitrile(n=1.52), poly methacrylonitrile(n=1.52), poly-sulfone(n=1.63), poly sulfide(n=1.60), phenoxy resin(n=1.5 to 1.6), polyethylacrylate(n=1.47), poly butyl acrylate(n=1.47), poly-2-ethylhexyl acrylate(n=1.46), poly-t-butyl acrylate(n=1.46), poly-3-ethoxypropylacrylate(n=1.47), polyoxycarbonyl tetra-methacrylate(n=1.47), polymethylacrylate(n=1.47 to 1.48), polyisopropylmethacrylate(n=1.47), polydodecyl methacrylate(n=1.47), polytetradecyl methacrylate(n=1.47), poly-n-propyl methacrylate(n=1.48), poly-3,3,5-trimethylcyclohexyl methacrylate(n=1.48), polyethylmethacrylate(n=1.49), poly-2-nitro-2-methylpropylmethacrylate(n=1.49), poly-1,1-diethylpropylmethacrylate (n=1.49), poly(meth)acrylates, such as polymethylmethacrylate(n=1.49), or a combination of any of these, can be used preferably as desired.

In some embodiment of the present invention, such thermoplastic polymers can be copolymerized if necessary.

A polymer, which can be copolymerized with the thermoplastic polymer described above is for example, urethane acrylate, epoxy acrylate, polyether acrylate, or, polyester acrylate (n=1.48 to 1.54) can also be employed. From the viewpoint of adhesiveness of the color conversion sheet, urethane acrylate, epoxy acrylate, and polyether acrylate are preferable.

According to the present invention, elastomers are incorporated into either thermoplastic polymer or thermosetting polymer based on their physical properties.

The matrix materials and the inorganic phosphors mentioned above in—Matrix materials, and in—Inorganic phosphors, can be preferably used for a fabrication of the color conversion sheet (100) and the light emitting diode device (200) of the present invention.

In some embodiments of the present invention, the composition can optionally further comprise one or more of additional inorganic phosphors, which emits blue or red light.

As an additional inorganic phosphor which emits blue or red light, any type of publicly known materials, for example as described in the second chapter of Phosphor handbook (Yen, Shinoya, Yamamoto), can be used if desired.

Without wishing to be bound by theory, it is believed that the blue light especially around 450 nm wavelength light may lead better plant growth, if it is combined with emission light from the inorganic phosphor having the peak wavelength of light emitted from the inorganic phosphor in the range from 660 nm to 740 nm, especially the combination of the blue light around 450 nm wavelength and emission light from the inorganic phosphor having the peak wavelength of light emitted from the inorganic phosphor in the range from 670 nm to 710 nm is preferable for better plant growth.

Thus, more preferably, the composition can further comprise at least one blue light emitting inorganic phosphor having peak wavelength of light emitted from the inorganic phosphor around 450 nm, like described in the second chapter of Phosphor handbook (Yen, Shinoya, Yamamoto).

Surface Treatment Method

The surface treatment method for the inorganic materials using the siloxane compound is not particularly limited.

For example, as popular methods, there are two kinds of methods as follows: 1) the method of surface treatment of inorganic material using siloxane compound before mixing with resin and 2) the method of surface treatment of inorganic material using siloxane compound to mix inorganic materials, siloxane compounds and resin at the same time. There are two kinds of treatment methods. In the first method mentioned above, there are two kinds of methods: the wet method and the dry method.

In a typical wet method using siloxane, firstly, siloxane compounds are mixed with solution dispersed inorganic materials. After that, the resultant materials in the solution are separated from the solvent, and then the heat treatment at less than 300° C. is performed to the resultant materials to acquire the final material. On the other hand, in a typical dry method using siloxane, siloxane compounds and inorganic materials are prepared at least, and the chemicals are mixed by Henschel mixer, which is one of the high-speed mixers and so on. After that, the resultant materials are heated in an oven at a temperature less than 300° C.

In the latter method for preparing the siloxane compound-coated inorganic materials, siloxane compounds and resin at least are prepared, and the surface treatment of the inorganic materials is completed while mixing it with siloxane compounds, inorganic materials and resin by the inflation machine and so on. The first method is more ordinary than the latter one. Preferably, the wet method of the first method is the best way but is not limited.

The siloxane-based compound is not particularly limited, but the silicone oil include, for example, triethoxycaprylylsilane (e.g. AES-3083 of Shin-Etsu Chemical Co., Ltd.), polymethyihydrosiloxane (e.g. KF-99P of Shin-Etsu Chemical Co., and SH1107 of Dow Corning Toray Co., Ltd.), polydimethylsiloxane-polymethylhydrosiloxane copolymer (e.g. KF-9901 of Shin-Etsu Chemical Co., Ltd.), triethoxysilylethyl polydimethylsiloxyethyl dimethicone (e.g. KF-9908 of Shin-Etsu Chemical Co., Ltd.), triethoxysilylethyl polydimethylsiloxyethyl hexyl dimethicone (e.g. KF-9909 of Shin-Etsu Chemical Co., Ltd.) and acrylicsilicone resin (e.g. KP-574 of Shin-Etsu Chemical Co., Ltd.).

As the silane coupling agent, for example, silane coupling agent having an amino group, e.g., γ-(2-aminoethyl)aminopropyltrimethoxysilane, γ-aminopropyltrimethoxysilane, n-β(aminoethyl)γ-aminopropyltrimethoxysilane and n-β(aminoethyl)γ-aminopropylmethyledimethoxysilane; silane coupling agent having a glycidyl group, e.g. γ-glycidoxypropyltrimethoxysilane and γ-Glycidoxypropyl methyldiethoxysilane; silane coupling agent having a mercapto group, e.g. γ-mercapto-propyltrimethoxysilane; silane coupling agent having a vinyl group, e.g. vinyltriethoxysilane, vinyltrimethoxysilane and vinyl tris(methoxyethoxy)silane; and silane coupling agent having a (meth)acryloyl group, e.g. γ-(meth)acryloyloxypropyltrimethoxysilane,γ-(meth)acryloyloxypropyltriethoxysilane and γ-(meth)acryloyloxypropyldimethoxymethylsilane are used.

The alkoxysilane may be methyltrimethoxysilane, dimethyldimethoxysilane, phenyltrimethoxysilane, diphenyldimethoxysilane, tetraethoxysilane, methyltriethoxysilane, dirnethyldiethoxysilane, phenyltriethoxysilane, n-propyltrimethoxysilane, n-propyltriethoxysilane, hexyltrimethoxysilane, hexyltriethoxysilane, decyltrimethoxisilane and trifluoropropyltrimethoxysilane.

The Additional Volume of the Siloxane Compound

The weight percentage of siloxane compounds to the volume of inorganic materials is preferably between 0.1 and 20 weight percentage. The siloxane compounds cannot perfectly cover the whole surface of the inorganic materials as they are using less than 0.1 weight percentage and their excessive addition of more than 20 weight percentage cause deterioration or discoloration of the resin. The siloxane compound is preferably treated at 1% to 5% by weight.

Additives

In some embodiments of the present invention, the composition can further comprise at least one additive, preferably the additive is selected from one or more members of the group consisting of photo initiators, co-polymerizable monomers, cross linkable monomers, bromine-containing monomers, sulfur-containing monomers, adjuvants, adhesives, insecticides, insect attractants, yellow dye, pigments, phosphors, metal oxides, Al, Ag, Au, dispersants, surfactants, fungicides, and antimicrobial agents.

In some embodiments of the present invention, the composition can embrace one or more of publicly available vinyl monomers that are co-polymerizable. Such as acrylamide, acetonitrile, diacetone-acrylamide, styrene, and vinyl-toluene or a combination of any of these.

According to the present invention, the composition can further include one or more of publicly available crosslinkable monomers.

For example, cyclopentenyl(meth)acrylates; tetra-hydro furfuryl-(meth)acrylate; benzyl (meth)acrylate; the compounds obtained by reacting a polyhydric alcohol with and α,β-unsaturated carboxylic acid, such as polyethylene-glycol di-(meth)acrylates (ethylene numbers are 2-14), tri-methylol propane di(mrneth)acrylate, tri-methylol propane di (meth)acrylate, tri-methylol propane tri-(meth)acrylate, tri-methylol propane ethoxy tri-(meth) acrylate, tri-methylol propane propoxy tri-(metha) acrylate, tetra-methylol methan tri-(meth) acrylate), tetra-methylol methane tetra(metha) acrylate, polypropylene glycol di(metha)acrylates (propylene number therein are 2-14), Di-penta-erythritol penta(meth)acrylate, di-penta-erythritol hexa(meth)acrylate, bis-phenol-A Polyoxyethylene di-(meth)acrylate, bis-phenol-A dioxyethylene di-(meth)acrylate, bis-phenol-A trioxyethylene di-(meth)acrylate, bis-phenol-A decaoxyethylene di-(meth)acrylate; the compounds obtained from an addition of an α,β-unsaturated carboxylic acid to a compound having glycidyl, such as tri-methylol propane triglycidylether triacrylate, bis-phenol A diglycidylether diacrylates; chemicals having poly-carboxylic acids, such as a phtalic anhydride; or chemicals having hydroxy and ethylenic unsaturated group, such as the esters with hydroxyethyl (meth)acrylate; alkyl-ester of acrylic acid or methacylic acid, such as methyl (meth)acrylate, ethyl (meth)acrylate, butyl (meth)acrylate, 2-ethyl hexyl (meth)acrylate; urethane (meth)acrylate, such as the reactants of Tolylene diisocyanate and 2-hydroxyethyl (meth)acrylate, the reactants of tri-methyl hexamethylene diisocyanate and cyclohexane dimethanol, and 2-hydroxyethyl (meth)acrylate; and a combination of any of these.

In a preferred embodiment of the present invention, the crosslinkable monomer is selected from the group consisting of tri-methylol-propane tri (meth)acrylate, di-pentaerythritol tetra-(meth)acrylate, di-pentaerythritol hexa-(meth)acrylate, bisphenol-A polyoxyethylene dimethacrylate and a combination thereof.

The vinyl monomers and the crosslinkable monomers described above can be used alone or in combination.

From the viewpoint of controlling the refractive index of the composition and/or the refractive index of the color conversion sheet according to the present invention, the composition can further comprise publicly known one or more of bromine-containing monomers, sulfur-containing monomers. The type of bromine and sulfur atom-containing monomers (and polymers containing the same) are not particularly limited and can be used preferably as desired.

For example, as brornine-containing monomers, new frontier@ BR-31, new Frontier@ BR-30, new Frontier® BR-42M (available from DAI-ICHI KOGYO SEIYAKU CO., LTD) or a combination of any of these, as the sulfur-containing monomer composition, IU-L2000, IU-L3000, IU-MS1010 (available from MITSUBISHI GAS CHEMICAL COMPANY, INC.) or a combination of any of these, can be used preferably.

In a preferred embodiment of the present invention, the photo initiator can be a photo initiator that can generates a free radical when it is exposed to an ultraviolet light or a visible light. For example, benzoin-methyl-ether, benzoin-ethyl-ether,r, benzoin-propyl-ether, benzoin-isobutyl-ether, benzoin-phenyl-ether, benzoin-ethers, benzophenone, N,N′-tetramethyl-4,4′-diaminobenzophenone (Michler's-ketone), N,N′-tetraethyl-4,4′diaminobenzophenone, benzophenones, benzil-dimethyl-ketal (Ciba specialty chemicals, IRGACURE® 651), benzil-diethyl-ketal, dibenzil ketals, 2,2-dimethoxy-2-phenylacetophenone, p-tert-butyldichloro acetophenone, p-dimethylamino acetophenone, acetophenones, 2,4-dimetyl thioxanthone, 2,4-diisopropyl thioxanthone, thioxanthones, hydroxy cyclohexyl phenyl ketone (Ciba specialty chemicals, IRGACURE® 184), 1-(4-isopropylphenyl)-2-hydroxy-2-methylpropane-1-on (Merck, DarocureE 1116), 2-hydroxy-2-methyl-1-phenylpropane-1-on (Merck, Darocure® 1173).

An adjuvant can enhance permeability of effective component (e.g. insecticide), inhibit precipitation of solute in the composition, or decrease a phytotoxicity. Here, a surfactant means it does not comprise or is not comprised by other additives, for example a spreading agent, a surface treatment and an adjuvant.

Preferably said adjuvant can be selected from the group consisting of a mineral oil, an oil of vegetable or animal origin, alkyl esters of such oils or mixtures of such oils and oil derivatives, and combination thereof. As one embodiment, the weight ratio of each 1 additive of dispersant, surfactant, fungicide, antimicrobial agent and antifungal agent, to the weight of the invention phosphor in the total amount of the composition is in the range from 50 wt. % to 200 wt. %, more preferably it is from 75 wt. % to 150 wt. %. Exemplified embodiment of an adjuvant is Approach BI (Trademark, Kao Corp.).

Formulation

In another aspect, the invention relates to a formulation comprising, essentially consisting of, or a consisting of the composition and a solvent.

Solvent

As a solvent, wide variety of publicly known solvents can be used preferably. There are no particular restrictions on the solvent as long as it can dissolve or disperse the matrix material, and the inorganic phosphor of the composition.

In a preferred embodiment of the present invention, the solvent can be selected from the group consisting of ethylene glycol monoalkyl ethers, such as, ethylene glycol monomethyl ether, ethylene glycol monoethyl ether, ethylene glycol monopropyl ether, and ethylene glycol monobutyl ether; diethylene glycol dialkyl ethers, such as, diethylene glycol dimethyl ether, diethylene glycol diethyl ether, diethylene glycol dipropyl ether, and diethylene glycol dibutyl ether; ethylene glycol alkyl ether acetates, such as, methyl cellosolve acetate and ethyl cellosolve acetate; propylene glycol alkyl ether acetates, such as, propylene glycol monomethyl ether acetate (PGMEA), propylene glycol monoethyl ether acetate, and propylene glycol monopropyl ether acetate; aromatic hydrocarbons, such as, benzene, toluene and xylene; ketones, such as, methyl ethyl ketone, acetone, methyl amyl ketone, methyl isobutyl ketone, and cyclohexanone; alcohols, such as, ethanol, propanol, butanol, hexanol, cyclohexanol, ethylene glycol, and glycerin; esters, such as, ethyl 3-ethoxypropionate, methyl 3-methoxypropionate and ethyl lactate; and cyclic asters, such as, γ-butyrolactone. Those solvents are used singly or in combination of two or more, and the amount thereof depends on the coating method and the thickness of the coating.

More preferably, propylene glycol alkyl ether acetates, such as, propylene glycol monomethyl ether acetate (hereafter “PGMEA”), propylene glycol monoethyl ether acetate, or propylene glycol monopropyl ether acetate and/or aromatic hydrocarbons, such as, benzene, toluene and xylene, can be used.

Even more preferably, benzene, toluene, or xylene can be used.

The amount of the solvent in the formulation can be freely controlled. For example, if the formulation is to be spray-coated, it can contain the solvent in an amount of 90 wt. % or more based on total amount of the formulation. Further, if a slit-coating method, which is often adopted in coating a large substrate, is to be carried out, the content of the solvent is normally 60 wt. % or more, preferably in the range from 70 wt. % to 95 wt. % based on the total amount of the formulation.

Optical medium

In another aspect, the invention relates to an optical medium (100) comprising at least the composition.

More details of the composition are described in the section of “Composition”. In other words, the optical medium (100) comprises at least the phosphor of the present invention and a matrix material.

In some embodiments of the invention, the optical medium (100) is a sheet, or a fiber mat.

According to the present invention, in some embodiments, the optical medium (100) can be rigid or flexible.

In some embodiments of the present invention, the optical medium (100) can be any structure. Such as plane, curved, wave formed structures to increase a growth of plant.

In some embodiments of the invention, the optical medium (100) is a fiber mat comprising at least a first fiber comprising at least the composition, preferably the optical medium (100) comprises a plurality of first fibers.

In some embodiments of the invention, the optical medium (100) wherein the first fiber comprises at least a core part and a cover layer, preferably said core part comprises at least the composition or the core part is made from the composition, and cover layer comprises at least a material selected from one or more members of the group consisting of adhesives, insecticides, pigments, phosphors, and antimicrobials.

According to the present invention, said cover layer can be partly or fully covers said core part of the fiber, preferably the cover layer fully covers the core part of the fiber.

In some embodiments of the invention, the optical medium (100), wherein the fiber mat further comprises a second fiber, wherein the second fiber does not comprise the phosphor used in the first fiber, preferably the second fiber comprises at least a material selected from one or more members of the group consisting of adhesives, insecticides, pigments, phosphors, and antimicrobials.

In some embodiments of the invention, the optical medium (100) is a sheet comprising at least a first layer (100a) comprising at least the composition or the first layer (100a) is made from the composition.

According to the present invention, said fiber mat can be fabricated by using publicly known spinning method. And said cover layer can be fabricated by using a known method such as a spinning, dip coating, bar coating, printing, and/or spin coating.

In some embodiments of the invention, the optical medium (100) is a combination of a sheet and a fiber mat.

In some embodiments of the invention, the sheet further comprises a second layer (100b), preferably the second layer (100b) comprises at least a material selected from one or more members of the group consisting of adhesives, insecticides, insect attractants, yellow dye, pigments, phosphors, metal oxides, Al, Ag, Au, and antimicrobials, more preferably said pigments are yellow pigments, blue pigments or a combination of these, and said phosphors are phosphors of the present invention or phosphors that can emit a light with a peak maximum light wavelength in the range from 350 nm to 500 nm, and/or 550 nm to 600 nm, more preferably in the range from 380 nm to 490 nm, and/or 570 nm to 590 nm.

In some embodiments of the present invention, the second layer (100b) comprises at least the phosphor of the invention, and

a second material selected from adhesives, and/or insecticides.

In some embodiments of the present invention, the second layer (100b) can further comprises a matrix material described in the section of “matrix material”.

According to the present invention, said phosphor is described in the section of “inorganic phosphors” above.

In some embodiments of the present invention, the second layer (100b) comprises at least a first material selected from one or more of the members of the group consisting of yellow pigments, yellow phosphors, yellow dyes, and insect attractants, and

a second material selected from adhesives, and/or insecticides.

Such second layer (100b) can be fabricated by a publicly known method. For example, spray coating, bar coating, slit coating, dip coating, spin coating, inkjet printing can be used.

In some embodiments of the present invention, the second layer (100b) of the optical medium (100) is a light reflecting layer, preferably the second layer (100b) as the reflecting layer comprises at least a light reflecting material which can reflect at least blue, red, and/or infrared light, even more preferably the second layer (100b) essentially consists of, or consists of one or more of light reflecting materials.

As a light reflecting material any kinds of less toxic known light reflecting materials such as Al, Cu, Ag, Au, and metal oxides can be used preferably, more preferably Al, or Cu is used as the light reflecting material from the view point of high light reflection at deep red-light wavelength and lower cost.

In some embodiments, said first layer is at least partially covered by said second layer, preferably at least one side of said first layer (100a) one side of the optical medium (100) is fully covered by the second layer.

In some embodiments, the optical medium (100) optionally may comprise a third layer (100c) or more layers.

In some embodiments, said first layer (100a), optionally the second layer (100b), the third layer (100c) or more layers can be sandwiched by, or fully or partially covered by one or more of optically transparent protection layers.

According to the present invention, said protection layer can be made from any publicly known transparent materials suitable for optical films.

Fabrication method for coating of optical medium (100) by the light reflecting material is not particularly limited. Publicly known methods such as vacuum deposition, sputtering, chemical vapor deposition, printing can be used.

In some embodiments of the invention, the optical the medium (100) comprises a first layer(100a), wherein the first layer (100a) comprises, in the first layer, at least a first area comprising the composition according to the present invention and a second area, preferably said second area comprising at least one additive described in the section of “Additive”.

In some embodiments of the invention, the optical medium (100) is a sheet and the concentration of the inorganic phosphor (110) in the sheet is varies from a high concentration on one side of the sheet to a low concentration of the opposite side of the sheet, preferably it is varying from a high concentration on one side of the sheet to a low concentration of the opposite side of the sheet in-plane direction.

In some embodiments of the invention, the optical medium (100), further comprises a substrate, preferably said substrate is an optically transparent substrate, colored substrate, selective light reflector, or a light reflector.

According to the present invention, the term “light reflect” means reflecting at least around 60% of incident light at a wavelength or a range of wavelength used during operation of the optical medium (100).

Preferably, it is over 70%, more preferably, over 75%, the most preferably, it is over 80%.

According to the present invention, the term “transparent” means at least around 60% of incident light transmittal at the thickness used in a the optical medium (100) and at a wavelength or a range of wavelength used during operation of the optical medium (100).

Preferably, it is over 70%, more preferably, over 75%, the most preferably, it is over 80%.

In some embodiments of the present invention, said reflector is a metal substrate, preferably Al substrate, Cu substrate, metal alloy substrate is useful from the view point of high light reflection at deep red-light wavelength and lower cost.

A material for the selective light reflection reflector is not particularly limited. Well known materials for a selective light reflector can be used preferably as desired.

According to the present invention, the selective light reflector can be a single layer or multiple layers.

In a preferred embodiment, the selective light reflector comprises at least a selective light reflecting layer selected from the group consisting of Al layer, Al+ MgF₂ stacked layers, Al+SiO stacked layers, Al+dielectric multiple layer, Au layer, dielectric multiple layer, Cr+Au stacked layers; with the selective light reflection layer more preferably being Al layer, Al+ MgF₂ stacked layers, Al+SiO stacked layers.

Preferably, said selective light reflecting layer is stacked onto a transparent substrate.

In general, the methods of preparing the selective light reflection layer can vary as desired and selected from well-known techniques.

In some embodiments, the selective light reflection layer expect for cholesteric liquid crystal layers can be prepared by a gas phase based coating process (such as Sputtering, Chemical Vapor Deposition, vapor deposition, flash evaporation), or a liquid-based coating process.

In some embodiments of the present invention, the optical medium is an optical sheet, for example, a color conversion sheet, a remote phosphor tape, or another sheet or a filter for agriculture.

According to the present invention, the term “sheet” comprises a film.

In some embodiments of the present invention, the layer thickness of the optical sheet is in the range from 5 μm to 1 mm, preferably it is in the range from 10 μm to 500 μm, more preferably it is from 30 μm to 200 μm, even more preferably from 50 μm to 100 μm from the view point of better light conversion property and lower production cost.

In some embodiments of the present invention, the total amount of the phosphor in the optical sheet is in the range from 0.01 wt. % to 30 wt. % based on the total amount of the matrix material, preferably it is from 0.1 wt. % to 10 wt. %, more preferably from 0.5 wt. % to 5 wt. %, furthermore preferably it is from 1 wt. % to 3 wt. %, from the view point of better light conversion property, lower production cost and less production damage of a production machine.

Optical device

In another aspect, the invention relates to an optical device (300) comprising the optical medium (301), or the composition and further comprising a light source, a light re-directing device, and/or a reflector.

Preferably said light source is a light emitting diode, or an organic light emitting diode.

In some embodiments of the present invention, the optical device (300) comprises at least one optical medium and a supporting part, preferably the supporting part comprises at least one attaching part to attach the optical medium, and optionally a base part to support optical medium and supporting part itself, more preferably the supporting part comprises one or more of attaching part to attach one or more of optical medium.

In a preferred embodiment of the present invention, the optical device is a lighting device, a light emitting diode device for agriculture, or building materials of greenhouse.

In another aspect, the invention relates to use of the composition, or formulation in an optical medium fabrication process.

In another aspect, the present invention furthermore relates to method for preparing the optical medium (100), wherein the method comprises following steps (a) and (b),

(a) providing the composition, or the formulation in a first shaping, preferably providing the composition onto a substrate or into an inflation moulding machine, and

(b) fixing the matrix material by evaporating a solvent and/or polymerizing the composition by heat treatment, or exposing the photosensitive composition under ray of light or a combination of any of these.

In a preferred embodiment, the method comprises following steps (a) and (b) in this sequence.

In some embodiments of the present invention, the composition in step (a) is provided by spincoating, spray coating, bar coating, or a slit coating method.

In a preferred embodiment of the present invention, the composition or the formulation in step (a) is provided into an inflation-molding machine and the matrix material is fixed by heat treatment of the machine.

In another aspect, the present invention furthermore relates to method for preparing the optical device (200), wherein the method comprises following step (A),

(A) providing the optical medium (100) in an optical device.

The details of the composition and the formulation are described in the section of “composition” and the section of “formulation”.

In another aspect, the present invention also relates to a light emitting phosphor represented by following general formula (VII),

A₅P₆O₂₅:Mn (VII)

wherein the component “A” stands for at least one cation selected from the group consisting of Si⁴⁺, Ge⁴⁺, Sn⁴⁺, Ti⁴⁺ and Zr⁴⁺, preferably Mn is Mn⁴⁺, more preferably said phosphor is Si₅P₆O₂₅:Mn⁴⁺.

In another aspect, the present invention also relates to a light emitting phosphor represented by following general formula (IX), or (X)

A¹₂B¹C¹O₆:Mn (IX)
A¹=at least one cation selected from the group consisting of Mg²⁺, Ca²⁺, Sr²⁺ and Ba²⁺ Zn²⁺, preferably A¹ is Ba²⁺;
B¹=at least one cation selected from the group consisting of Sc³⁺, Y³⁺, La³⁺, Ce^{3+,} B^{3+,} Al³⁺ and Ga³⁺, preferably B¹ is Y³⁺;
C¹=at least one cation selected from the group consisting of V⁵⁺, Nb⁵⁺ and Ta⁵⁺, preferably C¹ is Ta⁵⁺;

A²B²C²D¹O₆:Mn (X)
A²=at least one cation selected from the group consisting of Li⁺, Na⁺, K⁺, Rb⁺ and Cs⁺, preferably A² is Na⁺;
B²=at least one cation selected from the group consisting of Sc³⁺, La³⁺, Ce³⁺, B^{3+,} Al³⁺ and Ga³⁺, preferably B² is La³⁺;
C²=at least one cation selected from the group consisting of Mg²⁺, Ca²⁺, Sr²⁺, Ba²⁺ and Zn²⁺, preferably C² is Mg²⁺;
D¹=at least one cation selected from the group consisting of Mo⁶⁺ and W⁶⁺, preferably D¹ is W⁶⁺.

In another aspect, the present invention furthermore relates to use of the composition, the formulation, the optical medium (100), the optical device (200), or the phosphor, for agriculture, or for cultivation of algas, photosynthetic bacterias, and/or phytoplanktons.

Especially, according to the present invention, the optical medium (100) is useful for agriculture.

Particularly, the optical medium (100) is useful for a mulch cultivation sheet to cover at least a part of a ridge in a field or to cover at least a part of a surface of planter, such as a surface of nutrient film technique hydroponics system or a deep flow technique hydroponics system.

It is believed that the optical medium as a mulch cultivation sheet can control plant condition such as plant growth and to protect a plant and/or a ridge or a surface of planter as a mulch cultivation sheet at the same time preferably.

Therefore, more preferably, the invention relates to use of the optical medium (100) as a mulch cultivation sheet to cover a ridge in a field or to cover a surface of planter, preferably said planter is a nutrient film technique hydroponics system or a deep flow technique hydroponics system.

Even more preferably, one side of the optical medium (100) is coated by a light reflecting material which can reflect at least blue, red, and/or infrared light. As a light reflecting material any kinds of less toxic known light reflecting materials such as Al, metal oxides can be used preferably, more preferably Al, or AlO₂ is used as the light reflecting material.

Preferably, said one side of the optical medium (100) is fully covered by the light reflecting material.

Fabrication method for coating of optical medium (100) by the light reflecting material is not particularly limited. Publicly known methods such as vacuum deposition, sputtering, chemical vapor deposition, printing can be used.

In some embodiment, the optical medium (100) may be used to control growth of plankton, preferably said plankton is a phytoplankton.

In another aspect, the present invention relates to use of the composition, the formulation, the optical medium (100), the optical device (200), or the phosphor, for agriculture, or for cultivation of algae, bacteria, preferably said bacteria are photosynthetic bacteria, and/or planktons, preferably it is photo planktons.

In another aspect, the present invention relates to use of the composition, the formulation, the optical medium (100), the optical device (200), or the phosphor,

for improvement of controlling property of a phytoplankton condition, photosynthetic bacteria and/or alga, preferably acceleration of growth of phytoplankton, photosynthetic bacteria and/or alga; improvement of controlling property of plant condition, preferably controlling of a plant height; controlling of color of fruits; promotion and inhibition of germination; controlling of synthesis of chlorophyll and carotenoids, preferably by blue light; plant growth promotion; adjustment and/or acceleration of flowering time of plants; controlling of production of plant components, such as increasing production amount, controlling of polyphenols content, sugar content, vitamin content of plants; controlling of secondary metabolites, preferably controlling of polyphenols, and/or anthocyanins; controlling of a disease resistance of plants; controlling of ripening of fruits, or controlling of weight of plant.

In another aspect, the present invention relates to use of an inorganic phosphor having a peak wavelength of light emitted from the inorganic phosphor in the range of 650 nm or more, preferably in the range from 650 to 1500 nm, more preferably in the range from 650 to 1000 nm, even more preferably in the range from 650 to 800 nm, furthermore preferably in the range from 650 to 750 nm, much more preferably it is from 660 nm to 730 nm, further more preferably it is from 660 nm to 710 nm, the most preferably from 670 nm to 710 nm,

and/or at least one inorganic phosphor having a peak wavelength of light emitted from the inorganic phosphor in the range of 500 nm or less, preferably in the range from 250 nm to 500 nm, more preferably in the range from 300 nm to 500 nm, even more preferably in the range from 350 nm to 500 nm, furthermore preferably in the range from 400 nm to 500 nm, much more preferably in the range from 420 nm to 480 nm, the most preferably in the rage from 430 nm to 460 nm,

and/or at least one inorganic phosphor having a first peak wavelength of light emitted from the inorganic phosphor in the range of 500 nm or less, and a second peak wavelength of light emitted from the inorganic phosphor in the range of 650 nm or more, preferably the first peak wavelength of light emitted from the inorganic phosphor is in the range from 250 nm to 500 nm, and the second peak light emission wavelength is in the range from 650 nm to 1500 nm, more preferably the first peak wavelength of light emitted from the inorganic phosphor is in the range from 300 nm to 500 nm, and the second peak light emission wavelength is in the range from 650 nm to 1000 nm, even more preferably the first peak wavelength of light emitted from the inorganic phosphor is in the range from 350 nm to 500 nm, and the second peak light emission wavelength is in the range from 650 nm to 800 nm, furthermore preferably the first peak wavelength of light emitted from the inorganic phosphor is in the range from 400 nm to 500 nm, and the second peak light emission wavelength is in the range from 650 nm to 750 nm, much more preferably the first peak wavelength of light emitted from the inorganic phosphor is in the range from 420 nm to 480 nm, and the second peak light emission wavelength is in the range from 660 nm to 740 nm, the most preferably the first peak wavelength of light emitted from the inorganic phosphor is in the rage from 430 nm to 460 nm and the second peak wavelength of light emitted from the inorganic phosphor is in the range from 660 nm to 710 nm,

for agriculture, or for cultivation of algae, bacteria, preferably said bacteria are photosynthetic bacteria, and/or planktons, preferably it is photo planktons.

In another aspect, the present invention relates to use of an inorganic phosphor having a peak wavelength of light emitted from the inorganic phosphor in the range of 650 nm or more, preferably in the range from 650 to 1500 nm, more preferably in the range from 650 to 1000 nm, even more preferably in the range from 650 to 800 nm, furthermore preferably in the range from 650 to 750 nm, much more preferably it is from 660 nm to 730 nm, the most preferably from 670 nm to 710 nm,

and/or at least one inorganic phosphor having a peak wavelength of light emitted from the inorganic phosphor in the range of 500 nm or less, preferably in the range from 250 nm to 500 nm, more preferably in the range from 300 nm to 500 nm, even more preferably in the range from 350 nm to 500 nm, furthermore preferably in the range from 400 nm to 500 nm, much more preferably in the range from 420 nm to 480 nm, the most preferably in the rage from 430 nm to 460 nm,

and/or at least one inorganic phosphor having a first peak wavelength of light emitted from the inorganic phosphor in the range of 500 nm or less, and a second peak wavelength of light emitted from the inorganic phosphor in the range of 650 nm or more, preferably the first peak wavelength of light emitted from the inorganic phosphor is in the range from 250 nm to 500 nm, and the second peak light emission wavelength is in the range from 650 nm to 1500 nm, more preferably the first peak wavelength of light emitted from the inorganic phosphor is in the range from 300 nm to 500 nm, and the second peak light emission wavelength is in the range from 650 nm to 1000 nm, even more preferably the first peak wavelength of light emitted from the inorganic phosphor is in the range from 350 nm to 500 nm, and the second peak light emission wavelength is in the range from 650 nm to 800 nm, furthermore preferably the first peak wavelength of light emitted from the inorganic phosphor is in the range from 400 nm to 500 nm, and the second peak light emission wavelength is in the range from 650 nm to 750 nm, much more preferably the first peak wavelength of light emitted from the inorganic phosphor is in the range from 420 nm to 480 nm, and the second peak light emission wavelength is in the range from 660 nm to 740 nm, the most preferably the first peak wavelength of light emitted from the inorganic phosphor is in the rage from 430 nm to 460 nm and the second peak wavelength of light emitted from the inorganic phosphor is in the range from 660 nm to 710 nm,

for improvement of controlling property of a phytoplankton condition, photosynthetic bacteria and/or alga, preferably acceleration of growth of phytoplankton, photosynthetic bacteria and/or alga; improvement of controlling property of plant condition, preferably controlling of a plant height; controlling of color of fruits; promotion and inhibition of germination; controlling of synthesis of chlorophyll and carotenoids, preferably by blue light; plant growth promotion; adjustment and/or acceleration of flowering time of plants; controlling of production of plant components, such as increasing production amount, controlling of polyphenols content, sugar content, vitamin content of plants; controlling of secondary metabolites, preferably controlling of polyphenols, and/or anthocyanins; controlling of a disease resistance of plants; controlling of ripening of fruits, or controlling of weight of plant.

In another aspect, the present invention furthermore relates to method comprising at least applying the formulation, to at least one portion of a plant.

In another aspect, the present invention furthermore relates to modulating a condition of a plant, a plankton, or a bacterium, comprising at least following step (C),

(C) providing the optical medium (100), between a light source and a plant, between a light source and a plankton, preferably said plankton is a phytoplankton, between a light source and a bacterium, preferably said bacterium is a photosynthetic bacterium, and/or

providing the optical medium (100), over a ridge in a field or over a surface of planter, preferably said planter is a nutrient film technique hydroponics system or a deep flow technique hydroponics system to control plant growth.

In a preferred embodiment of the present invention, the optical medium (100) is provided directly onto a ridge in a field or onto a surface of planter.

According to the present invention, the light source is the sun or an artificial light source, preferably said artificial light source is a light emitting diode.

In another aspect, the present invention further relates to a plant, a plankton, or a bacterium obtained or obtainable by the method. Preferably said plankton is a phytoplankton, and said bacterium is a photosynthetic bacterium.

In another aspect, the present invention furthermore relates to a container comprising at least one plant, one plankton, or a bacterium obtained or obtainable by the method of the present invention. Preferably said plankton is a phytoplankton, and said bacterium is a photosynthetic bacterium.

According to the present invention, the plant can be flowers, vegetables, fruits, grasses, trees and horticultural crops (preferably flowers and horticultural crops, more preferably flowers). As one embodiment of the invention, the plant can be foliage plants. Exemplified embodiments of grasses are a poaceae, bambuseae (preferably sasa, phyllostachys), oryzeae (preferably oryza), pooideae (preferably poeae), triticeae (preferably elymus), elytrigia, hordeum, triticum, secale, arundineae, centotheceae, chloridoideae, Hordeum vulgare, Avena sativa, secale cereal, andropogoneae (preferably coix), cymbopogon, saccharum, sorghum, zea (preferably Zea mays), Sorghum bicolor, Saccharum officinarum, coix lacryma-jobi var., paniceae (preferably panicum), Setaria, echinochloa (preferably panicum miliaceum), Echinochloa esculenta, and Setaria italic. Embodiments of vegetables are stem vegetables, leaves vegetables, flowers vegetables, stalk vegetables, bulb vegetables, seed vegetables (preferably beans), roots vegetables, tubers vegetables, and fruits vegetables. One embodiment of the plant can be Gaillardia, Lettuce, Rucola, Komatsuna (Japanese mustard spinach) or Radish (preferably Gaillardia, Lettuce, or Rucola). The environment of growing plant can be natural environment, a green house, a plant factory and indoor cultivation, preferably natural environment and a green house. One embodiment of the natural environment is an outside farm.

### PREFERABLE EMBODIMENTS

### Embodiment 1

A composition comprising at least one inorganic fluorescent material having a peak wavelength of light emitted from the inorganic fluorescent material in the range from 650 nm to 730 nm, preferably it is from 660 nm to 710 nm,

and/or at least one inorganic fluorescent material having a first peak wavelength of light emitted from the inorganic fluorescent material in the range from 400 nm to 500 nm and a second peak wavelength of light emitted from the inorganic fluorescent material from 600 nm to 750 nm, preferably the first peak wavelength of light emitted from the inorganic fluorescent material is in the range from 430 nm to 490 nm, and the second peak light emission wavelength is in the range from 650 nm to 720 nm, more preferably the first peak wavelength of light emitted from the inorganic fluorescent material is 450 nm and the second peak wavelength of light emitted from the inorganic fluorescent material is in the range from 660 nm to 710 nm,

and a matrix material.

Preferably, said inorganic fluorescent material is an inorganic phosphor.

### Embodiment 2

The composition according to embodiment 1, wherein said inorganic fluorescent material is selected from the group consisting of sulfides, thiogallates, nitrides, oxy-nitrides, silicates, metal oxides, apatites, quantum sized materials, and a combination of any of these, preferably, it is a Mn activated metal oxide phosphor.

### Embodiment 3

The composition according to embodiment 1 or 2, wherein the inorganic fluorescent material is selected from one or more of Mn activated metal oxide phosphors represented by following formulae (I) to (VI)

AₓB_{y}O_{z}:Mn⁴⁺ (I)

wherein A is a divalent cation and is selected from one or more members of the group consisting of Mg²⁺, Zn²⁺, Cu²⁺, Co²⁺, Ni²⁺, Fe²⁺, Ca²⁺, Sr²⁺, Ba²⁺, Mn²⁺, Ce²⁺ and Sn²⁺, B is a tetravalent cation and is Ti³⁺, Zr³⁺ or a combination of these; x≥1; y≥0; (x+2y)=z, preferably A is selected from one or more members of the group consisting of Mg²⁺, Ca²⁺, Sr²⁺, Ba²⁺, Zn²⁺, B is Ti³⁺, Zr³⁺ or a combination of Ti³⁺ and Zr³⁺, x is 2, y is 1, z is 4, more preferably, formula (I) is Mg₂TiO₄:Mn⁴⁺;

XₐZ_{b}O_{c}:Mn⁴⁺ (II)

wherein X is a monovalent cation and is selected from one or more members of the group consisting of Li⁺, Na⁺, K⁺, Ag⁺ and Cu⁺; Z is a tetravalent cation and is selected from the group consisting of Ti³⁺ and Zr³⁺; b≥0; a≥1; (0.5a+2b)=c, preferably X is Li⁺, Na⁺ or a combination of these, Z is Ti³⁺, Zr³⁺ or a combination of these a is 2, b is 1, c is 3, more preferably formula (II) is Li₂TiO₃:Mn⁴⁺;

D_{d}EₑO_{f}:Mn⁴⁺ (III)

wherein D is a divalent cation and is selected from one or more members of the group consisting of Mg²⁺, Zn²⁺, Cu²⁺, Cu²⁺, Ni²⁺, Fe²⁺, Ca²⁺, Sr²⁺, Ba²⁺, Mn²⁺, Ce²⁺ and Sn²⁺; E is a trivalent cation and is selected from the group consisting of Al³⁺, Ga³⁺, Lu³⁺, Sc³⁺, La³⁺ and In³⁺; e≥10; d≥0; (d+1.5e)=f, preferably D is Ca²⁺, Sr²⁺, Ba²⁺ or a combination of any of these, E is Al^{3+,} Gd³⁺ or a combination of these, d is 1, e is 12, f is 19, more preferably formula (III) is CaAl₁₂O₁₉:Mn⁴⁺;

D_{g}EₕOᵢ:Mn⁴⁺ (IV)

wherein D is a trivalent cation and is selected from one or more members of the group consisting of Al³⁺, Ga³⁺, Lu³⁺, Sc³⁺, La³⁺ and In³⁺; E is a trivalent cation and is selected from the group consisting of Al³⁺, Ga³⁺, Lu³⁺, Sc³⁺, La³⁺ and In³⁺; h≥0; a≥g; (1.5 g+1.5h)=l, preferably D is La³⁺, E is Al³⁺, Gd³⁺ or a combination of these, g is 1, h is 12, i is 19, more preferably formula (IV) is LaAlO₃:Mn⁴⁺;

GⱼJₖLₗOₘ:Mn⁴⁺ (V)

wherein G is a divalent cation and is selected from one or more members of the group consisting of Mg²⁺, Zn²⁺, Cu²⁺, Co²⁺, Ni²⁺, Fe²⁺, Ca²⁺, Sr²⁺, Ba²⁺, Mn²⁺, Ce²⁺ and Sn²⁺; J is a trivalent cation and is selected from the group consisting of Y³⁺, Al³⁺, Ga³⁺, Lu³⁺, Sc³⁺, La³⁺ and In³⁺; L is a trivalent cation and is selected from the group consisting of Al³⁺, Ga³⁺, Lu³⁺, Sc³⁺, La³⁺ and In³⁺; l≥0; k≥0; j≥0; (j+1.5k+1.51)=m, preferably G is selected from Ca²⁺, Sr²⁺, Ba²⁺, or a combination of any of these, J is Y³⁺, Lu³⁺ or a combination of these, L is Al³⁺, Gd³⁺ or a combination of these, j is 1, k is 1, l is 1, m is 4, more preferably it is CaYAlO₄:Mn⁴⁺; and

MₙQₒRₚO_{q}:Eu,Mn (VI)

wherein M and Q are divalent cations and are, independently or dependently of each other, selected from one or more members of the group consisting of Mg²⁺, Zn²⁺, Cu²⁺, Co²⁺, Ni²⁺, Fe²⁺, Ca²⁺, Sr²⁺, Ba²⁺, Mn²⁺, Ce²⁺ and Sn²⁺; R is Ge³⁺, Si³⁺, or a combination of these; n≥2; o≥0; p≥1; (n+o+2.0p)=q, preferably M is Ca²⁺, Sr²⁺, Ea²⁺ or a combination of any of these, Q is Mg²⁺, Ca²⁺, Sr²⁺, Ba²⁺, Zn²⁺ or a combination of any of these, R is Ge³⁺, Si³⁺, or a combination of these, n is 3, o is 1, p is 2, q is 8, more preferably it is (Ca, Ba, Sr)₃MgSi₂O₈:Eu, Mn.

### Embodiment 4

The composition according to any one of embodiments 1 to 3,

wherein the inorganic fluorescent material is a Mn activated metal oxide phosphor represented by chemical formula (VI).

### Embodiment 5

The composition according to any one of embodiments 1 to 4, wherein the matrix material wherein the matrix material comprises a polymer selected from the group consisting of photosetting polymer, a thermosetting polymer, a thermoplastic polymer, and a combination of any of these.

### Embodiment 6

The composition according to any one of embodiments 1 to 5, the total amount of the phosphor of the composition is in the range from 0.01 wt. % to 30 wt. % based on the total amount of the matrix material, preferably it is from 0.1 wt. % to 10 wt. %, more preferably from 0.5 wt. % to 5 wt. %, furthermore preferably it is from 1 wt. % to 3 wt. %.

### Embodiment 7

The composition according to any one of embodiments 1 to 6, further comprises at least one additive selected from one or more members of the group consisting of photo initiators, co-polymerizable monomers, cross linkable monomers, bromine-containing monomers, sulfur-containing monomers, adjuvants, dispersants, surfactants, fungicides, antimicrobial agents, and antifungal agents.

### Embodiment 8

A formulation comprising the composition according to any one of embodiments 1 to 7, and a solvent.

### Embodiment 9

An optical medium (100) comprising the composition according to any one of embodiments 1 to 7.

### Embodiment 10

An optical device (300) comprising the optical medium (100) according to embodiment 8.

### Embodiment 11

Use of the composition according to any one of embodiments 1 to 7, or the formulation according to embodiment 8 in an optical medium fabrication process.

### Embodiment 12

Use of the optical medium (100) according to embodiment 9, in an optical device or for agriculture.

### Embodiment 13

Use of the inorganic fluorescent material having the peak wavelength of light emitted from the inorganic fluorescent material in the range from 650 nm to 730 nm,

and/or at least one inorganic fluorescent material having a first peak wavelength of light emitted from the inorganic fluorescent material in the range from 400 nm to 500 nm and a second peak wavelength of light emitted from the inorganic fluorescent material from 600 nm to 750 nm, preferably the first peak wavelength of light emitted from the inorganic fluorescent material is in the range from 430 nm to 490 nm, and the second peak light emission wavelength is in the range from 650 nm to 720 nm, more preferably the first peak wavelength of light emitted from the inorganic fluorescent material is 450 nm and the second peak wavelength of light emitted from the inorganic fluorescent material is in the range from 660 nm to 710 nm,

with a matrix material in an optical medium (200).

### Embodiment 14

Method for preparing the optical medium (100), wherein the method comprises following steps (a) and (b) in this sequence;

(a) providing the composition according to any one of embodiments 1 to 7, or the formulation according to embodiment 8 onto a substrate or into an inflation moulding machine, and

(b) fixing the matrix material by evaporating a solvent and/or polymerizing the composition by heat treatment, or exposing the photosensitive composition under ray of light or a combination of any of these.

### Embodiment 15

Method for preparing the optical device (200) according to embodiment 10, wherein the method comprises following step (A);

(A) providing the optical medium (100) according to embodiment 9, in an optical device (200).

### Technical Effects

The present invention provides one or more of following effects; improvement of controlling property of a phytoplankton condition, photosynthetic bacteria and/or alga, preferably acceleration of growth of phytoplankton, photosynthetic bacteria and/or alga; improvement of controlling property of plant condition, preferably controlling of a plant height; controlling of color of fruits; promotion and inhibition of germination; controlling of synthesis of chlorophyll and carotenoids, preferably by blue light; plant growth promotion; adjustment and/or acceleration of flowering time of plants; controlling of production of plant components, such as increasing production amount, controlling of polyphenols content, sugar content, vitamin content of plants; controlling of secondary metabolites, preferably controlling of polyphenols, and/or anthocyanins; controlling of a disease resistance of plants; controlling of ripening of fruits, or controlling of weight of plant.

The synthesis examples and working examples below provide descriptions of the present inventions but not intended to limit scopes of the inventions.

### WORKING EXAMPLES

### Comparative Example 1

A large plant growth-promoting sheet without phosphor having 50 μm layer thickness is made from Petrothene180 (Trademark, Tosoh Corporation) as a polymer with using a Kneading machine and inflation moulding machine. Then all plant seedlings of Boston lettuce are covered by the sheet and it is exposed to light from an artificial LED lighting having peak wavelength from 550-600 nm for 16 days. Finally, their fresh weight is measured.

### Comparative Example 2

A large plant growth-promoting sheet without phosphor having 50 μm layer thickness is made in the same manner as described in comparative example 1.

Then all plant seedlings of Boston lettuce are covered by the sheet and it is exposed to sunlight for 16 days. Finally, their fresh weight is measured.

### Synthesis Example 1: Synthesis of Mg₂TiO₄:Mn⁴⁺

The phosphor precursors of Mg₂TiO₄:Mn⁴⁺ are synthesized by a conventional solid state reaction. The raw materials of magnesium oxide, titanium oxide and manganese oxide are prepared with a stoichiometric molar ratio of 2.000:0.999:0.001. The chemicals are put in a mixer and mixed by a pestle for 30 minutes. The resultant materials are oxidized by firing at 1000° C. for 3 hours in air.

To confirm the structure of the resultant materials, XRD measurements are performed using an X-ray diffractometer (RIGAKU RAD-RC).

Photoluminescence (PL) spectra is measured by using a spectrofluorometer (JASCO FP-6500) at room temperature. The photoluminescence excitation spectrum shows a UV region from 300-400 nm while the emission spectrum exhibited a deep red region from 660-670 nm.

### Working Example 1: Composition 1

20 g of Mg₂TiO₄:Mn⁴⁺ phosphor from synthesis example 1 and 0.6 g of siloxane compound (SH 1107, manufactured by Toray Dow Corning Co., Ltd.) are put in a Waring blender, and mixed at a low speed for 2 minutes. After uniformly surface-treating in this process, the resultant materials are heat-treated in an oven at 140° C. for 90 minutes.

Then, final surface treated Mg₂TiO₄:Mn⁴⁺ phosphors with aligned particle sizes are acquired by shaking with a stainless screen with an opening of 63 μm.

The agricultural material is prepared using Mg₂TiO₄:Mn⁴⁺ as a phosphor, and Petrothene180 (Trademark, Tosoh Corporation) as a polymer. 2 wt % of Mg₂TiO₄:Mn⁴⁺ phosphors in the polymer is mixed to get Composition 1.

### Working Example 2: Optical Medium 1

Composition 1 is provided into a Kneading machine and inflation-moulding machine then, a large plant growth-promoting sheet having 50 μm layer thickness is formed.

Then all plant seedlings of Boston lettuce are covered by the sheet and it is exposed to light from artificial LED lighting for 16 days. Finally, their fresh weight is measured.

The present invention demonstrated a fresh weight increase from 20.23 g to 22.34 g in the plants under the growth-promoting sheet compared to the sheet of comparative example 1. The height of the plant from working example 2 is taller than the height of the plant from comparative example 1. The leaves of the plant from working example 2 are bigger, and the color of the plant leaves from working example 2 is deeper green than the leaves of the plant from comparative example 1.

In addition or instead of measuring a weight of a plant, the leaves area of 1 plant can be measured by known method and device. A leaf area meter can be used to measure it. One embodiment is a LI3000C Area Meter (Li—COR Corp.). The leaves area can be measured by separating all leaves from 1 plant body, getting a photo image or scan each 1 leaf, and processing these images.

### Synthesis Example 2: Synthesis of CaMgSi₂O₆:Eu²⁺, Mn²⁺

CaCl₂*2H₂O (0.0200 mol, Merck), SiO₂ (0.05 mol, Merck), EuCl₃*6H₂O (0.0050 mol, Auer-Remy), MnCl₂*4H₂O (0.0050 mol, Merck), and MgCl₂*4H₂O (0.0200 mol, Merck) are dissolved in deionized water. NH₄HCO₃ (0.5 mol, Merck) is dissolved separately in deionized water.

The two aqueous solutions are simultaneously stirred into deionized water. The combined solution is heated to 90° C. and evaporated to dryness.

Then, the residue is annealed at 1000° C. for 4 hours under an oxidative atmosphere, and the resulting oxide material is annealed at 1000° C. for 4 hours under a reductive atmosphere.

To confirm the structure of the resultant materials, XRD measurements are performed using an X-ray diffractometer (RIGAKU RAD-RC). Photoluminescence (PL) spectra is measured using a spectrofluorometer (JASCO FP-6500) at room temperature. The photoluminescence excitation spectrum of CaMgSi₂O₆:Eu^{2+,} Mn²⁺ shows a UV region from 300 to 400 nm while the emission spectrum exhibited in a deep red region from 660 to 670 nm.

The advantage of CaMgSi₂O₆:Eu²⁺, Mn²⁺ is less toxicity, environment friendly and can emit light having peak light wavelength around 660 nm-670 nm which is more useful for plant growth than a red-light emission of a conventional phosphor having peak light emission less than 650 nm.

### Working Example 3: Composition 2

20 g of CaMgSi₂O₆:Eu^{2+,} Mn²⁺ phosphor from working example 1 and 0.6 g of siloxane compound (SH 1107, manufactured by Toray Dow Corning Co., Ltd.) are put in a Waring blender, and mixed at low speed for 2 minutes. After uniformly surface-treating in this process, the resultant materials are heat-treated in an oven at 140° C. for 90 minutes. Then, final surface treated CaMgSi₂O₆:Eu^{2+,} Mn²⁺ phosphors with aligned particle sizes are acquired by shaking with a stainless screen with an opening of 63 μm.

The agricultural material is prepared using CaMgSi₂O₆:Eu²⁺, Mn²⁺ as a phosphor, and Petrothene180 (Trademark, Tosoh Corporation) as a polymer. 2 wt % of CaMgSi₂O₆:Eu^{2+,} Mn²⁺ phosphors in the polymer is mixed to get Composition 2.

### Working Example 4: Optical Medium 2

Composition 2 is provided into a Kneading machine and inflation-moulding machine then, a large plant growth-promoting sheet having 50 μm layer thickness is formed.

Then all plant seedlings of Boston lettuce are covered by the sheet and it is exposed to sunlight for 16 days. Finally, their fresh weight is measured.

The present invention demonstrated a weight increase from 21.45 g to 23.81 g in the plants under the growth-promoting sheet compared to the sheet of comparative example 2. From agricultural point of view, it is a significant improvement. The height of the plant from working example 4 is taller than the height of the plant from comparative example 2. The leaves of the plant from example 4 are bigger, and the color of the plant leaves from example 4 is deeper green than the leaves of the plant from comparative example 2.

### Synthesis Example 3: Synthesis of Ba₂YTaO₆:Mn⁴⁺

The present example refers to the synthesis of the phosphor Ba₂YTaO₆:Mn⁴⁺ with a Mn concentration of 1 mol %. The phosphor is prepared according to conventional solid-state reaction methods, using Ba₂CO₃, Y₂O₃, Ta₂O₅ and MnO₂ as starting materials. These chemicals are mixed according to their stoichiometric ratio and mixed with acetone in an agate mortar.

The powder thus obtained is pelletized at 10 MPa, placed into an alumina container and heated at 1400° C. for 6 hours in the presence of air. After cooling the residue is well grinded for characterization. For confirmation of the structure, XRD measurements are performed using an X-ray diffractometer. Photoluminescence (PL) spectra is taken using a spectrofluorometer at room temperature.

The XRD patterns proofs that the main phase of the product consisted of Ba₂YTaO₆. The photoluminescence excitation spectrum shows a UV region from 300-400 nm while the emission spectrum exhibits a deep red region from 630 to 710 nm. Excitation and emission spectra are provided in FIG. 6.

The absorption peak wavelengths of Ba₂YTaO₆:Mn⁴⁺ is 310-340 nm, and the emission peak wavelength is in the range from 680-700 nm.

### Synthesis Example 4: Synthesis of NaLaMgWO₆:Mn⁴⁺

The present example refers to the synthesis of the phosphor NaLaMgWO₆:Mn⁴⁺ with a Mn concentration of 1 mol %. The phosphor is prepared according to conventional solid-state reaction methods, using Na₂CO₃, La₂O₃, MgO, WO₃ and MnO₂ as starting materials. La₂O₃ is preheated at 1200° C. for 10 hours in the presence of air. The chemicals are mixed according to their stoichiometric ratio and mixed with acetone in an agate mortar.

The powder thus obtained is pelletized at 10 MPa, placed into an alumina container and heated at 1300° C. for 6 hours in the presence of air. After cooling the residue is well grinded for characterization. For confirmation of the structure, XRD measurements are performed using an X-ray diffractometer. Photoluminescence (PL) spectra are taken using a spectrofluorometer at room temperature.

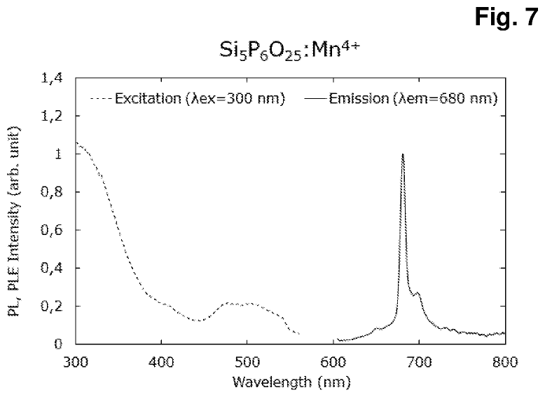

The XRD patterns proofs that the main phase of the product consisted of NaLaMgWO₆. The photoluminescence excitation spectrum shows a UV region from 300-400 nm while the emission spectrum exhibited a deep red region from 660-750 nm. The excitation and emission spectra are provided in FIG. 7.

The absorption peak wavelengths of NaLaMgWO₆:Mn⁴⁺ is 310-330 nm, and the emission peak wavelength is in the range from 690-720 nm.

### Synthesis Example 5: Synthesis of Si₅P₆O₂₅:Mn⁴⁺

The present example refers to the preparation of the phosphor Si₅P₆O₂₅:Mn⁴⁺ with an Mn concentration of 0.5 mol %. The phosphor has been prepared according to conventional solid-state reaction methods, using SiO₂, NH₄H₂PO₄ and MnO₂ as starting materials. The educts are mixed according to their stoichiometric ratio and mixed with acetone in an agate mortar. The powder thus obtained is pelletized at 10 MPa, placed into an alumina container, pre-heated 300° C. for 6. The pre-heated powder is grinded, pelletized at 10 MPa, placed again in an alumina container and heated at 1.000° C. for another 12 hours in the presence of air. After cooling the residue is well grinded for characterization.

For confirmation of the structure, XRD measurements are performed using an X-ray diffractometer. Photoluminescence (PL) spectra are taken using a Spectro fluorometer at room temperature. The XRD patterns proofed that the main phase of the product consisted of Si₅P₆O₂₅.

The photoluminescence excitation spectrum showed a UV region from 300 nm to 400 nm while the emission spectrum exhibited a deep red region at 690 nm. Excitation and emission spectra are provided in FIG. 7.

### Working Example 5

20 g of Mg₂TiO₄:Mn⁴⁺ phosphors synthesized in the same manner as described in the synthesis example 1 and 0.6 g of siloxane compound (SH 1107, manufactured by Toray Dow Corning Co., Ltd.) are put in a Waring blender, and mixed at a low speed for 2 minutes. After uniformly surface-treating in this process, the resultant materials are heat-treated in an oven at 140° C. for 90 minutes.

Then, final surface treated Mg₂TiO₄:Mn⁴⁺ phosphors with aligned particle sizes are acquired by shaking with a stainless screen with an opening of 63 μm.

The tunnel sheet with Mg₂TiO₄:Mn⁴⁺ is prepared using Mg₂TiO₄:Mn⁴⁺ as a fluorescent material, and Petrothene180 (Trademark, Tosoh Corporation) as a polymer. 2 wt % of Mg₂TiO₄:Mn⁴⁺ phosphors in the polymer is mixed and a large plant growth-promoting sheet having 50 μm layer thickness is formed by using a Kneading machine and inflation-moulding machine.

Then all plant seedlings of Holly basil are covered by the sheet and it is exposed to the sun light for 28 days. Finally, their fresh weight is measured.

### Working Example 6

The tunnel sheet is prepared in the same manner as described in working example 5 except for 4 wt. % of Mg₂TiO₄:Mn⁴⁺ phosphors in the polymer is mixed.

Then all plant seedlings of Holly basil are covered by the sheet and it is exposed to the sun light for 28 days. Finally, their fresh weight is measured.

### Working Example 7

The tunnel sheet is prepared in the same manner as described in working example 5 except for 1 wt. % of Mg₂TiO₄:Mn⁴⁺ phosphors in the polymer is mixed.

Then all plant seedlings of Holly basil are covered by the sheet and it is exposed to the sun light for 28 days. Finally, their fresh weight is measured.

### Comparative Example 3

All plant seedlings of Holly basil are exposed to the sun light without any tunnel sheet for 28 days. Finally, their fresh weight is measured.

Table 1 shows the results of the measurements.

TABLE 1

| | |
|---|---|
| Working example 5 | 146 g |
| Working example 6 | 146 g |
| Working example 7 | 146 g |
| Comparative example 3 | 122 g |

1. A composition comprising at least one inorganic phosphor having a peak wavelength of light emitted from the inorganic phosphor in the range of 650 nm or more, preferably in the range from 650 to 1500 nm, more preferably in the range from 650 to 1000 nm, even more preferably in the range from 650 to 800 nm, furthermore preferably in the range from 650 to 750 nm, much more preferably it is from 660 nm to 730 nm, the most preferably from 670 nm to 710 nm,
and/or at least one inorganic phosphor having a peak wavelength of light emitted from the inorganic phosphor in the range of 500 nm or less, preferably in the range from 250 nm to 500 nm, more preferably in the range from 300 nm to 500 nm, even more preferably in the range from 350 nm to 500 nm, furthermore preferably in the range from 400 nm to 500 nm, much more preferably in the range from 420 nm to 480 nm, the most preferably in the rage from 430 nm to 460 nm,
and/or at least one inorganic phosphor having a first peak wavelength of light emitted from the inorganic phosphor in the range of 500 nm or less, and a second peak wavelength of light emitted from the inorganic phosphor in the range of 650 nm or more, preferably the first peak wavelength of light emitted from the inorganic phosphor is in the range from 250 nm to 500 nm, and the second peak light emission wavelength is in the range from 650 nm to 1500 nm, more preferably the first peak wavelength of light emitted from the inorganic phosphor is in the range from 300 nm to 500 nm, and the second peak light emission wavelength is in the range from 650 nm to 1000 nm, even more preferably the first peak wavelength of light emitted from the inorganic phosphor is in the range from 350 nm to 500 nm, and the second peak light emission wavelength is in the range from 650 nm to 800 nm, furthermore preferably the first peak wavelength of light emitted from the inorganic phosphor is in the range from 400 nm to 500 nm, and the second peak light emission wavelength is in the range from 650 nm to 750 nm, much more preferably the first peak wavelength of light emitted from the inorganic phosphor is in the range from 420 nm to 480 nm, and the second peak light emission wavelength is in the range from 660 nm to 740 nm, the most preferably the first peak wavelength of light emitted from the inorganic phosphor is in the rage from 430 nm to 460 nm and the second peak wavelength of light emitted from the inorganic phosphor is in the range from 660 nm to 710 nm,
and a matrix material.

2. The composition according to claim 1, wherein the phosphor is nontoxic phosphors, preferably it is edible phosphors.

3. The composition according to claim 1, wherein said inorganic phosphor is selected from the group consisting of metal-oxide phosphors, silicate and halide phosphors, phosphate phosphors, borate and borosilicate phosphors, aluminate, gallate and alumosilicate phosphors, sulfate, sulfide, selenide and telluride phosphors, nitride and oxynitride phosphors and SiAlON phosphors, preferably, it is a metal oxide phosphor, more preferably it is a Mn activated metal oxide phosphor or a Mn activated phosphate based phosphor, even more preferably it is a Mn activated metal oxide phosphor.

4. The composition according to claim 1, wherein the inorganic phosphor is selected from one or more of Mn activated metal oxide phosphors or Mn activated phosphate based phosphors represented by following formulae (I) to (VII), (IX) to (X),
AₓB_{y}Oₓ:Mn⁴⁺ (I)
wherein A is a divalent cation and is selected from one or more members of the group consisting of Mg²⁺, Zn²⁺, Cu²⁺, Co²⁺, Ni²⁺, Fe²⁺, Ca²⁺, Sr²⁺, Ba²⁺, Mn²⁺, Ce²⁺ and Sn²⁺, B is a tetravalent cation and is Ti³⁺, Zr³⁺ or a combination of these; x≥1; y≥0; (x+2y)=z, preferably A is selected from one or more members of the group consisting of Mg²⁺, Ca²⁺, Sr²⁺, Ba²⁺, Zn²⁺, B is Ti³⁺, Zr³⁺ or a combination of Ti³⁺ and Zr³⁺, x is 2, y is 1, z is 4, more preferably, formula (I) is Mg₂TiO₄:Mn⁴⁺;
XₐZ_{b}O_{c}:Mn⁴⁺ (II)
wherein X is a monovalent cation and is selected from one or more members of the group consisting of Li⁺, Na⁺, K⁺, Ag⁺ and Cu⁺; Z is a tetravalent cation and is selected from the group consisting of Ti³⁺ and Zr³⁺; b≥0; a≥1; (0.5a+2b)=c, preferably X is Li⁺, Na⁺ or a combination of these, Z is Ti³⁺, Zr³⁺ or a combination of these a is 2, b is 1, c is 3, more preferably formula (II) is Li₂TiO₃:Mn⁴⁺;
D_{d}EₑO_{f}:Mn⁴⁺ (III)
wherein D is a divalent cation and is selected from one or more members of the group consisting of Mg²⁺, Zn²⁺, Cu²⁺, Co²⁺, Ni, Fe²⁺, Ca²⁺, Sr²⁺, Ba²⁺, Mn²⁺, Ce²⁺ and Sn²⁺; E is a trivalent cation and is selected from the group consisting of Al³⁺, Ga³⁺, Lu³⁺, Sc³⁺, La³⁺ and In³⁺; e≥10; d≥0; (d+1.5e)=f, preferably D is Ca²⁺, Sr²⁺, Ba²⁺ or a combination of any of these, E is Al³⁺, Gd³⁺ or a combination of these, d is 1, e is 12, f is 19, more preferably formula (III) is CaAl₁₂O₁₉:Mn⁴⁺;
D_{g}EₕOᵢ:Mn⁴⁺ (IV)
wherein D is a trivalent cation and is selected from one or more members of the group consisting of Al³⁺, Ga³⁺, Lu³⁺, Sc³⁺, La³⁺ and In³⁺; E is a trivalent cation and is selected from the group consisting of Al³⁺, Ga³⁺, Lu³⁺, Sc³⁺, La³⁺ and In³⁺; h≥0; a≥g; (1.5 g+1.5h)=l, preferably D is La³⁺, E is Al³⁺, Gd³⁺ or a combination of these, g is 1, h is 12, i is 19, more preferably formula (IV) is LaAlO₃:Mn⁴⁺;
GⱼJₖLₗOₘ:Mn⁴⁺ (V)
wherein G is a divalent cation and is selected from one or more members of the group consisting of Mg²⁺, Zn²⁺, Cu²⁺, Co²⁺, Ni²⁺, Fe²⁺, Ca²⁺, Sr²⁺, Ba²⁺, Mn²⁺, Ce²⁺ and Sn²⁺; J is a trivalent cation and is selected from the group consisting of Y³⁺, Al³⁺, Ga³⁺, Lu³⁺, Sc³⁺, La³⁺ and In³⁺; L is a trivalent cation and is selected from the group consisting of Al³⁺, Ga³⁺, Lu³⁺, Sc₃₊, La³⁺ and In³⁺; l≥0; k≥0; j≥0; (j+1.5k+1.5l)=m, preferably G is selected from Ca²⁺, Sr²⁺, Ba²⁺ or a combination of any of these, J is Y³⁺, Lu³⁺ or a combination of these, L is Al³⁺, Gd³⁺ or a combination of these, j is 1, k is 1, l is 1, m is 4, more preferably it is CaYAlO₄:Mn⁴⁺; and
MₙQₒRₚO_{q}:Eu,Mn (VI)
wherein M and Q are divalent cations and are, independently or dependently of each other, selected from one or more members of the group consisting of Mg²⁺, Zn²⁺, Cu²⁺, Co²⁺, Ni²⁺, Fe²⁺, Ca²⁺, Mn²⁺, Ce²⁺; R is Ge³⁺, Si³⁺, or a combination of these; n≥1; o≥0; p≥1; (n+o+2.0p)=q, preferably M is Ca²⁺, Q is Mg²⁺, Ca²⁺, Zn²⁺ or a combination of any of these, R is Si³⁺, n is 1, o is 1, p is 2, q is 6, more preferably it is CaMgSi₂O₆:Eu²⁺, Mn²⁺;
A₅P₆O₂₅:Mn⁴⁺ (VII)
wherein the component “A” stands for at least one cation selected from the group consisting of Si⁴⁺, Ge⁴⁺, Sn⁴⁺, Ti⁴⁺ and Zr⁴⁺;
A¹₂B¹C¹O₆:Mn⁴⁺ (IX)
A¹=at least one cation selected from the group consisting of Mg²⁺, Ca²⁺, Sr²⁺ and Ba²⁺ Zn²⁺, preferably A¹ is Ba²⁺;
B¹=at least one cation selected from the group consisting of Sc³⁺, Y³⁺, La³⁺, Ce³⁺, B³⁺, Al³⁺ and Ga³⁺, preferably B¹ is Y³⁺;
C¹=at least one cation selected from the group consisting of V⁵⁺, Nb⁵⁺ and Ta⁵⁺, preferably C¹ is Ta⁵⁺;
A²B²C²D¹O₆:Mn⁴⁺ (X)
A²=at least one cation selected from the group consisting of Li⁺, Na⁺, K⁺, Rb⁺ and Cs⁺, preferably A² is Na⁺;
B²=at least one cation selected from the group consisting of Sc³⁺, La³⁺, Ce³⁺, B³⁺, Al³⁺ and Ga³⁺, preferably B² is La³⁺;
C²=at least one cation selected from the group consisting of Mg²⁺, Ca²⁺, Sr²⁺, Ba²⁺ and Zn²⁺, preferably C² is Mg²⁺;
D¹=at least one cation selected from the group consisting of Mo⁶⁺ and W⁶⁺, preferably D¹ is W⁶⁺.

5. The composition according to claim 1, wherein the inorganic phosphor is a Mn activated metal oxide phosphor represented by chemical formula (I).

6. The composition according to claim 1, wherein the matrix material is an organic material, and/or an inorganic material, preferably the matrix material is an organic material, more preferably it is an organic oligomer or an organic polymer material, even more preferably an organic polymer selected from the group consisting of a transparent photosetting polymer, a thermosetting polymer, a thermoplastic polymer, or a combination of any of these.

7. The composition according to claim 1, the total amount of the phosphor of the composition is in the range from 0.01 wt. % to 30 wt. % based on the total amount of the composition, preferably it is from 0.1 wt. % to 10 wt. %, more preferably from 0.5 wt. % to 5 wt. %, furthermore preferably it is from 1 wt. % to 3 wt. %.

8. The composition according to claim 1, the composition further comprises at least one additive, preferably the additive is selected from one or more members of the group consisting of photo initiators, co-polymerizable monomers, cross linkable monomers, bromine-containing monomers, sulfur-containing monomers, adjuvants, adhesives, insecticides, insect attractants, yellow dye, pigments, phosphors, metal oxides, Al, Ag, Au, dispersants, surfactants, fungicides, and antimicrobial agents.

9. A formulation comprising the composition according to claim 1, and a solvent.

10. An optical medium (100) comprising the composition according to claim 1;
wherein preferably the optical medium (100) is a sheet, or a fiber mat;
wherein preferably the optical medium (100) is a fiber mat comprising at least a first fiber comprising said composition;
wherein optionally the optical medium (100) comprises at least a first fiber which comprises at least a core part and a cover layer, preferably said core part comprises said composition, and the cover layer comprises a material selected from one or more members of the group consisting of adhesives, insecticides, pigments, phosphors, and antimicrobials;
wherein optionally and preferably the optical medium (100) is the fiber mat which further comprises a second fiber, wherein the second fiber does not comprise the phosphor used in the first fiber;
wherein optionally and preferably the optical medium (100) is is a sheet comprising at least a first layer (100a) comprising at least said composition;
wherein optionally the sheet further comprises a second layer (100b), preferably the second layer (100b) comprises a material selected from one or more members of the group consisting of adhesives, insecticides, pigments, phosphors, and antimicrobials;
wherein optionally and preferably the optical medium (100) comprises a first layer (100a), wherein the first layer (100a) comprises at least a first area comprising said composition according and a second area;
wherein optionally and preferably the optical medium (100) is a sheet and the concentration of the inorganic phosphor (110) in the sheet is varies from a high concentration on one side of the sheet to a low concentration of the opposite side of the sheet, preferably it is varying from a high concentration on one side of the sheet to a low concentration of the opposite side of the sheet in-plane direction;
and wherein optionally and preferably the optical medium (100) further comprises a substrate, preferably said substrate is an optically transparent substrate, colored substrate, or a light reflector.

11-19. (canceled)

20. An optical device (300) comprising the optical medium (100) of claim 10 and further comprising a light source, a light re-directing device, and/or a reflector;
and wherein optionally the optical device (300) comprises at least one optical medium (100) and a supporting part (410);
and wherein optionally in the optical device (300) the supporting part (410) comprises at least one attaching part to attach the optical medium (100), and optionally a base part to support the optical medium (100) and supporting part (410) itself, preferably the supporting part (410) comprises one or more of attaching part to attach one or more of optical mediums.

21-23. (canceled)

24. Method for preparing the optical medium (100), wherein the method comprises following steps (a) and (b),
(a) providing the composition according to claim 1 in a first shaping, preferably providing the composition onto a substrate or into an inflation moulding machine, and
(b) fixing the matrix material by evaporating a solvent and/or polymerizing the composition by heat treatment, or exposing the photosensitive composition under ray of light or a combination of any of these.

25. Method for preparing the optical device (200), wherein the method comprises following step (A);
(A) providing the optical medium (100) according to claim 10 in an optical device (200).

26. A light emitting phosphor represented by following general formula (VII),
A₅P₆O₂₅:Mn (VII)
wherein the component “A” stands for at least one cation selected from the group consisting of Si⁴⁺, Ge⁴⁺, Sn⁴⁺, Ti⁴⁺ and Zr⁴⁺, preferably Mn is Mn4⁺, more preferably said phosphor is Si₅P₆O₂₅:Mn⁴⁺; or
a light emitting phosphor represented by following general formula (IX), or (X)
A¹₂B¹C¹O₆:Mn (IX)
A¹=at least one cation selected from the group consisting of Mg²⁺, Ca²⁺, Sr²⁺ and Ba²⁺ Zn²⁺, preferably A¹ is Ba²⁺;
B¹=at least one cation selected from the group consisting of Sc³⁺, Y³⁺, La³⁺, Ce³⁺, B³⁺, Al³⁺ and Ga³⁺, preferably B¹ is Y³⁺;
C¹=at least one cation selected from the group consisting of V⁵⁺, Nb⁵⁺ and Ta⁵⁺, preferably C¹ is Ta⁵⁺;
A²B²C²D¹O₆:Mn (X)
A²=at least one cation selected from the group consisting of Li⁺, Na⁺, K⁺, Rb⁺ and Cs⁺, preferably A² is Na⁺;
B²=at least one cation selected from the group consisting of Sc³⁺, La³, Ce³⁺, B³⁺, Al³⁺ and Ga³⁺, preferably B² is La³⁺;
C²=at least one cation selected from the group consisting of Mg²⁺, Ca²⁺, Sr²⁺, Ba²⁺ and Zn²⁺, preferably C² is Mg²⁺;
D¹=at least one cation selected from the group consisting of Mo⁶⁺ and W⁶⁺, preferably D¹ is W⁶⁺;
and
wherein preferably Mn is Mn⁴⁺;
and
wherein preferably the phosphor is NaLaMgWO₆:Mn⁴⁺ or Ba₂YTaO₆:Mn⁴⁺.

27-29. (canceled)

30. A method for agriculture, or for cultivation of algae, bacteria, preferably said bacteria are photosynthetic bacteria, and/or planktons, preferably it is photo planktons, comprising using the composition according to claim 1,
which method is preferably for improvement of controlling property of a phytoplankton condition, photosynthetic bacteria and/or alga, preferably acceleration of growth of phytoplankton, photosynthetic bacteria and/or alga; improvement of controlling property of plant condition, preferably controlling of a plant height; controlling of color of fruits; promotion and inhibition of germination; controlling of synthesis of chlorophyll and carotenoids, preferably by blue light; plant growth promotion; adjustment and/or acceleration of flowering time of plants; controlling of production of plant components, such as increasing production amount, controlling of polyphenols content, sugar content, vitamin content of plants; controlling of secondary metabolites, preferably controlling of polyphenols, and/or anthocyanins; controlling of a disease resistance of plants; controlling of ripening of fruits, or controlling of weight of plant.

31. (canceled)

32. A method for agriculture, or for cultivation of algae, bacteria, preferably said bacteria are photosynthetic bacteria, and/or planktons, preferably it is photo planktons, comprising using an inorganic phosphor having a peak wavelength of light emitted from the inorganic phosphor in the range of 650 nm or more, preferably in the range from 650 to 1500 nm, more preferably in the range from 650 to 1000 nm, even more preferably in the range from 650 to 800 nm, furthermore preferably in the range from 650 to 750 nm, much more preferably it is from 660 nm to 730 nm, the most preferably from 670 nm to 710 nm,
and/or at least one inorganic phosphor having a peak wavelength of light emitted from the inorganic phosphor in the range of 500 nm or less, preferably in the range from 250 nm to 500 nm, more preferably in the range from 300 nm to 500 nm, even more preferably in the range from 350 nm to 500 nm, furthermore preferably in the range from 400 nm to 500 nm, much more preferably in the range from 420 nm to 480 nm, the most preferably in the rage from 430 nm to 460 nm,
and/or at least one inorganic phosphor having a first peak wavelength of light emitted from the inorganic phosphor in the range of 500 nm or less, and a second peak wavelength of light emitted from the inorganic phosphor in the range of 650 nm or more, preferably the first peak wavelength of light emitted from the inorganic phosphor is in the range from 250 nm to 500 nm, and the second peak light emission wavelength is in the range from 650 nm to 1500 nm, more preferably the first peak wavelength of light emitted from the inorganic phosphor is in the range from 300 nm to 500 nm, and the second peak light emission wavelength is in the range from 650 nm to 1000 nm, even more preferably the first peak wavelength of light emitted from the inorganic phosphor is in the range from 350 nm to 500 nm, and the second peak light emission wavelength is in the range from 650 nm to 800 nm, furthermore preferably the first peak wavelength of light emitted from the inorganic phosphor is in the range from 400 nm to 500 nm, and the second peak light emission wavelength is in the range from 650 nm to 750 nm, much more preferably the first peak wavelength of light emitted from the inorganic phosphor is in the range from 420 run to 480 nm, and the second peak light emission wavelength is in the range from 660 nm to 740 nm, the most preferably the first peak wavelength of light emitted from the inorganic phosphor is in the rage from 430 nm to 460 nm and the second peak wavelength of light emitted from the inorganic phosphor is in the range from 660 nm to 710 nm;
which method is preferably for improvement of controlling property of a plankton condition, preferably a phytoplankton condition, bacteria, preferably a photosynthetic bacterium and/or alga, preferably acceleration of growth of phytoplankton, photosynthetic bacteria and/or alga; improvement of controlling property of plant condition, preferably controlling of a plant height controlling of color of fruits; promotion and inhibition of germination; controlling of synthesis of chlorophyll and carotenoids, preferably by blue light; plant growth promotion; adjustment and/or acceleration of flowering time of plants; controlling of production of plant components, such as increasing production amount, controlling of polyphenols content, sugar content, vitamin content of plants; controlling of secondary metabolites, preferably controlling of polyphenols, and/or anthocyanins; controlling of a disease resistance of plants; controlling of ripening of fruits, or controlling of weight of plant.

33. (canceled)

34. Method comprising at least applying the formulation of claim 9, to at least one portion of a plant.

35. Method for modulating a condition of a plant, plankton, and/or a bacterium, comprising at least following step (C),
(C) providing the optical medium (100), between a light source and a plant, between a light source and a plankton, preferably said plankton is a phytoplankton, between a light source and a bacterium, preferably said bacterium is a photosynthetic bacterium,
or
providing the optical medium (100) according to claim 10, over a ridge in a field or over a surface of planter, preferably said planter is a nutrient film technique hydroponics system or a deep flow technique hydroponics system to control plant growth; and
wherein optionally the light source is the sun or an artificial light source, preferably said artificial light source is a light emitting diode.

36. (canceled)

37. A plant or a plankton or a bacterium obtained or obtainable by the method of claim 35, which is optionally in a container.

38. (canceled)
